(19) United States
(12) Patent Application Publication
(10) Pub. No.: US 2024/0192059 A1
(43) Pub. Date: Jun. 13, 2024

(54) DEVICE AND METHOD FOR MONITORING AN EMISSION TEMPERATURE OF A RADIATION EMITTING ELEMENT

(71) Applicant: trinamiX GmbH, Ludwigshafen am Rhein (DE)

(72) Inventors: Tobias BAUMGARTNER, Ludwigshafen am Rhein (DE); Sourabh KULKARNI, Mannheim (DE); Celal Mohan OEGUEN, Ludwigshafen am Rhein (DE)

(21) Appl. No.: 18/554,076

(22) PCT Filed: May 6, 2022
(86) PCT No.: PCT/EP22/62261

§ 371 Date: Oct. 5, 2023

(30) Foreign Application Priority Data
May 7, 2021 (EP) 21172760.7
Dec. 2, 2021 (EP) 21212001.8

(51) Int. Cl. G01J 5/28; G01J 5/06; G01J 5/52

(52) U.S. Cl. CPC G01J 5/28; G01J 5/06; G01J 5/52; G01J 2005/065; G01J 2005/283

(57) ABSTRACT

The present invention refers to a device (112) for monitoring an emission temperature of at least one radiation emitting element (114), a heating system (110) for heating at the least one radiation emitting element (114) to emit thermal radiation at an emission temperature, a method for monitoring an emission temperature of at least one radiation emitting element (114) and method for heating the at least one radiation emitting element (114) to emit thermal radiation at an emission temperature. Herein, the device (112) for monitoring an emission temperature of at least one radiation emitting element (114) comprises—at least one light source (125), wherein the light source is configured to emit optical radiation at least partially towards the at least one radiation emitting element (114); —at least one radiation sensitive element (126), wherein the at least one radiation sensitive element (126) has at least one sensor region (128), wherein the at least one sensor region (128) comprises at least one photosensitive material selected from at least one photoconductive material, wherein the at least one sensor region (128) is designated for generating at least one sensor signal depending on an intensity of the thermal radiation emitted by the at least one radiation emitting element (114) and received by the sensor region (128) within at least one wavelength range, wherein the sensor region (128) is further designated for generating at least one further sensor signal depending on an intensity of the optical radiation emitted by the at least one light source (125) and received by the sensor region (128) within at least one further wavelength range, wherein the at least one radiation sensitive element (126) is arranged in a manner that the thermal radiation travels through at least one transition material (116) prior to being received by the at least one radiation sensitive element (126), wherein at least one of the at least one light source (125) and the at least one radiation sensitive element (126) is arranged in a manner that the optical radiation travels through the at least one transition material (116) and impinges the at least one radiation emitting element (114) prior to being received by the at least one radiation sensitive element (126); and—at least one evaluation unit (138), wherein the at least one evaluation unit (138) is configured to determine the emission temperature of the at least one radiation emitting element (114) by using values for the intensity of the thermal radiation and the optical radiation.

### FIELD OF THE INVENTION

The present invention refers to a device and a method for monitoring an emission temperature of at least one radiation emitting element as well as to a heating system and a method for heating at the least one radiation emitting element to emit thermal radiation at an emission temperature. The methods and devices may, in particular, be used for controlling the emission temperature of at least one piece of cookware being heated on a ceramic glass cooktop. However, further applications are conceivable.

### PRIOR ART

Monitoring a temperature of at least one object that emits thermal radiation, in particular within the infrared spectral range, through at least one transition material arranged in a fashion that the thermal radiation travels through the at least one transition material before it can be received by at least one radiation sensitive element, in general, requires knowledge about an emissivity of the at least one object. In particular, the temperate of at least one piece of cookware which is measured through a ceramic glass cooktop requires knowledge about the emissivity of the at least one particular piece of cookware. As a result, the temperature of different kinds of objects can, in practice, not be determined correctly without applying a repetitive adjustment of measurement settings.

U.S. Pat. No. 9,035,223 B2 discloses an induction heat cooking device that finishes preheating in a short time and maintains the temperature obtained at the finish of the preheating. The induction heat cooking device includes a heating coil for heating a cooking container by induction, an inverter circuit for providing a high frequency current to the heating coil, an operation unit including an operation mode setting unit for setting an operation mode of the inverter circuit, an infrared sensor for detecting an infrared light that is emitted from a bottom surface of the cooking container, a control unit for controlling an output of the inverter circuit based on an output of the infrared sensor, and a setting inputted to the operation unit, and a notification unit. However, only a single infrared sensor is disclosed herein.

However, for determining the temperature of an object in an emissivity-independent fashion multiple sensors can be used at different wavelengths, wherein sensor signals generated by each sensor can be combined. Jacqueline Elder and Andrew M. Trotta, Contractor Report on Evaluation of Sensor and Control Technologies to Address Cooking Fires on Glass Ceramic Cooktops, available under https://www.cpsc.gov/s3fs-public/pdfs/ceramic.PDF, describes a dual wavelength measurement system through CERAN®.

J. Paradiso, L. Borque, P. Bramson, M. Laibowitz, H. Ma, M. Malinowski, Sensing Systems for Glass Ceramic Cooktops, Internal MIT Media Lab Report, Jul. 18, 2003, describes a PbS based measurement of the temperature of CERAN® with two detectors, one active, one darkened to remove the thermal effects. Thus, both documents describe dual-wave measurements in the infrared spectral range allowing a determination of a temperature without knowing the emissivity of the cookware. U.S. Pat. No. 6,169,486 B1 describes a sensor having a first wavelength range which is used to measure the radiation from the cookware, while a second detector having a second wavelength range is used to measure the utensil.

In particular, it is known that a ceramic glass cooktop exhibits a partial transparency for infrared radiation at wavelengths of 1 μm to 5 μm. Herein, the infrared radiation at wavelengths of 1 μm to 1.4 μm is especially weak at temperatures around approx. 80° C. to 100° C. at which relevant boiling processes of aqueous liquids, such as water, occur. Further, the infrared radiation at wavelengths of 3.4 μm to 4.2 μm is known to be relevant for oil ignition processes.

In general, a temperature measurement involving a ceramic glass cooktop may be performed by using at least one of the following approaches:
measuring a temperature at a bottom of the ceramic glass cooktop and using this piece of information to determine a state of the cookware;
providing an opening in the ceramic glass cooktop and positioning a window having a high transmissivity for infrared radiation, wherein the window may comprise sapphire or calcium fluoride, into the opening in a fashion that the infrared radiation emitted by the cookware can be measured through the window, whereby an intensity of the infrared radiation at the location of the infrared sensor can be increased, however, on cost of a reduction of a mechanical strength of the ceramic glass cooktop;
elevating an infrared sensor above the ceramic glass cooktop and measuring a temperature at a lateral side of the cookware, for which a specially prepared cookware having an emissivity strip on a lateral side is required.

WO 2015/018891 A1 discloses a method for operating a cooking device with a cooking hob and a heating device for heating a cooking area. Further, a measurement system comprising a sensor device for detecting a first characteristic variable for temperatures of the cooking area is provided. According to the invention, a parameter is determined. The parameter describes a static property of the measurement system and is taken into consideration for determining the temperature of the cooking area.

U.S. Pat. No. 10,356,853 B2 discloses an induction cooking system which includes a base, one or more side walls, an induction coil, and an infrared temperature sensor. The base includes a base surface associated therewith, wherein the base surface includes a window disposed within the base surface. The one or more side walls define a well above the base surface, wherein the well is configured to receive a vessel disposed above the base surface. The induction coil is disposed within the base, wherein the induction coil defines a first surface that is disposed below the base surface, a second surface that is disposed opposite from the first surface, and an aperture disposed adjacent to the window and extending from a first surface toward a second surface of the induction coil. The infrared temperature sensor is disposed adjacent to the window and within the aperture.

EP 3 572 730 A2 discloses a remote temperature measurement of cookware through a ceramic glass plate using an infrared sensor, taking into account the emissivity of the cookware which is continuously evaluated, and taking into account the temperature of the ceramic glass plate.

Owing to their low spectral sensitivity, a use of photovoltaic detectors apart from extended-InGaS is rather limited. However, extended-InGaS detectors are particularly expensive and are, therefore, not commonly used in a multiple sensor setup.

Temperature sensors using the pyroelectric effect are not suitable for determining unmodulated radiation. However, the radiation emitted by the cookware is, generally, not modulated such that mechanical or optical choppers would be required, whereby complexity and price of the measurement setup would increase, while its life span would decrease.

Although thermopiles offer a cheap alternative due to their broad-band spectral sensitivity and their ability to detect unmodulated radiation, their detectivity is, however, rather low compared to quantum detectors, such as photovoltaic detectors, resulting in a rather low resolution.

Moreover, at least one further object differing from the at least one piece of cookware may, in particular in an accidental fashion, be positioned on the top of the ceramic glass cooktop. Herein, the at least one further object, such as a plastic container or a burn stain located on the ceramic glass cooktop, may constitute a fire hazard. Thus, it would be desirable to be able to detect such further object that may constitute a potential fire hazard and to prevent an operation of the ceramic glass cooktop in this event.

A further safety relevant feature is a recognition of a boil-dry condition of an aqueous liquid, such as water. After the aqueous liquid in the at least one piece of cookware may have been completely evaporated, the temperature of the at least one piece of cookware may, typically, increase rapidly. Therefore, it would be desirable to detect a velocity by which the temperature of the at least one piece of cookware may increase in order to determine a presence of a boil-dry condition.

U.S. Pat. No. 6,300,606 B1 discloses a method for detecting a boil dry condition of a cooking utensil or vessel placed on a glass-ceramic cooking surface of a cooking unit having at least one cooking zone includes determination of definite criteria for occurrence of the boil dry condition based on the first and second derivatives of the cooking zone temperature, on detection of operation of the heating element power control device and the power input to the heating element in accordance with a three stage comparison of the cooking zone temperature and the shutoff temperature. When the measured cooking zone temperature is well below the shutoff temperature and after a predetermined time interval from last operation of the heating element control device by an operator, the occurrence of positive first and second derivatives signals the boil dry condition. The device for detecting a boil dry condition of a cooking utensil or vessel placed on a glass-ceramic cooking surface of a cooking unit having at least one cooking zone includes a cooking zone temperature sensor; signal generating devices for detecting operation of the heating element power control device, for energy input to the heating element and for the shutoff temperature and a control and analysis device for receiving these input signals and for generating a control signal indicative of the boil dry condition according to the above-described method using the input signals. However, no specific sensor types are mentioned herein.

JP 2011 138733 A discloses an induction heating cooking appliance comprising a top plate, a coil, infrared sensors, wavelength selection filters, a difference process circuit and temperature calculation means. The top plate may comprise glass ceramics. The infrared sensors may comprise photodiodes. The wavelength selective filters may comprise short pass filters, long pass filters or band pass filters. A first wavelength selective filter selectively transmits a first wavelength range while a second wavelength selective filter selectively transmits a different second wavelength range. The difference process circuit determines the difference of the outputs of infrared sensors. The temperature calculation means refers to the outputs of the infrared sensors as well as to the output of the difference process circuit for calculating the temperature of a to-be-heated material.

JP 2003 109736 A discloses a cooking heater apparatus comprising infrared intensity detection means, a coil, a power supply and a control circuit. The control circuit comprises temperature detection means for detecting the temperature of a heated object as well as output control means. The detection means detect radiation received via a window part in top plate and filters, respectively. The infrared intensity is detected in at least two different wavelength ranges, which are used to perform the temperature detection.

JP 2006 292439 A discloses a temperature detector comprising a substrate, a first optical system, a second optical system, a first Si photodiode, a second Si photodiode, a signal-processing unit and a temperature detecting element. The optical systems may be convex lenses. The Si photodiodes may have different sensitivity characteristics. A wavelength selection filter may be provided in front of the light-receiving surface of each Si photodiode. The signal-processing unit is connected with each Si photodiode and uses the respective photodiode outputs as input.

EP 2 704 521 A1 discloses a domestic appliance device and a method for its operating. The device has a sensing unit comprising two light sensors and a beam splitter unit dividing outgoing radiation into two partial beams by a measuring point. The partial beams are provided in addition with the light sensors to-be-detected. The sensor unit comprises a light guide unit for directing light from the measuring point to the beam splitting unit. The light guide unit is formed by an optical fiber. The sensing unit comprises a filter unit arranged between the beam splitter unit and the light sensors.

WO 2019/124084 A1 discloses an induction heating apparatus comprising a top plate, a detection unit, an optical filter, a heating coil, a control unit, and a lens. The filter characteristic of the optical filter is switched by moving a movable structure of the optical filter formed by a MEMS device, and the spectral sensitivity characteristic of the detection unit is changed accordingly.

EP 3 572 777 A1 a stove guard comprising a data processing unit and a temperature sensor arrangement for receiving thermal radiation. The temperature arrangement comprises at least three detector elements. The data processing unit is configured to compare the detector signals output by different detector elements to determine the temperature of an object in the field of view.

### Problem to be Solved

It is, therefore, an object of the present invention to provide a device and a method for monitoring an emission temperature of at least one radiation emitting element as well as a heating system and a method for heating at the least one radiation emitting element to emit thermal radiation at an emission temperature, which may at least partially overcome the above-mentioned technical disadvantages and shortcomings of known.

In particular, it would be desirable to be able to monitor in a simple and easy fashion a temperature of at least one object that emits thermal radiation, in particular within the infrared spectral range, specifically at least one piece of cookware, through at least one transition material, specifically a ceramic glass cooktop, arranged in a manner that the thermal radiation travels through the at least one transition material before it can be received by at least one radiation sensitive element without being required to know an emissivity of the at least one object.

### SUMMARY OF THE INVENTION

This problem is solved by a device and a method for monitoring an emission temperature of at least one radiation emitting element as well as a heating system and a method for heating at the least one radiation emitting element to emit thermal radiation at an emission temperature having the features of the independent claims. Preferred embodiments that can be implemented in isolated fashion or in arbitrary combination are listed in the dependent claims and through the specification.

In a first aspect of the present invention, a device for monitoring an emission temperature of at least one radiation emitting element, wherein the at least one radiation emitting element emits thermal radiation at the emission temperature, disclosed. Accordingly, the device for comprises:
at least one light source, wherein the light source is configured to emit optical radiation at least partially towards the at least one radiation emitting element;
at least one radiation sensitive element, wherein the at least one radiation sensitive element has at least one sensor region, wherein the at least one sensor region comprises at least one photosensitive material selected from at least one photoconductive material, wherein the at least one sensor region is designated for generating at least one sensor signal depending on an intensity of the thermal radiation emitted by the at least one radiation emitting element and received by the sensor region within at least one wavelength range, wherein the sensor region is further designated for generating at least one further sensor signal depending on an intensity of the optical radiation emitted by the at least one light source and received by the sensor region within at least one further wavelength range, wherein the at least one radiation sensitive element is arranged in a manner that the thermal radiation travels through at least one transition material prior to being received by the at least one radiation sensitive element, wherein at least one of the at least one light source and the at least one radiation sensitive element is arranged in a manner that the optical radiation travels through the at least one transition material and impinges the at least one radiation emitting element prior to being received by the at least one radiation sensitive element; and
at least one evaluation unit, wherein the at least one evaluation unit is configured to determine the emission temperature of the at least one radiation emitting element by using values for the intensity of the thermal radiation and the optical radiation.

As generally used, the term “device” refers to a spatial entity which comprises at least the above-listed components. Herein, the listed components may be separate components. Alternatively, two or more of the components may be integrated into a common component. Further, the device or at least one component thereof may be integrated into a further device as a portion thereof, wherein the further device may, preferably, be a heating system as described below in more detail or a portion thereof. However, an at least partial integration of the device or a portion thereof in a different further device may also be feasible.

As used herein, the term “thermal radiation” refers to an emission of a plurality of photons which are generated by at least one radiation emitting element and whose wavelengths cover at least a portion of the infrared spectral range. As generally used, the term “infrared” refers to a wavelength of 780 nm to 1000 μm, wherein a wavelength of 780 nm to 3 μm is designated as “near infrared” and a wavelength of 3 μm to 8 μm as “mid infrared”, while a wavelength of 8 μm to 15 μm is designated as “far infrared”. Specifically, a wavelength range of 0.8 μm, 1 μm, 1.3 μm, 1.5 μm or 2 μm up to 2.5 μm, 2.8 μm, 3 μm, or 5 μm may, particularly, be preferred for the purposes of the present invention. However, depending on the materials as used in the device, at least one further wavelength may also be feasible.

As further used herein, the term “emitting thermal radiation” refers to a procedure of generating and spatially distributing a radiant flux of photons having a particular wavelength by the at least one radiation emitting element. As further used herein, the term “radiation emitting element” refers to a source of thermal radiation which is designed to generate thermal radiation which, in particular, covers at least a portion of the infrared spectral range as defined above. With regard to the present invention, the at least one radiation emitting element may, in particular, be or comprise at least one piece of cookware. As generally used, the term “cookware” refers to a receptacle which is designed for being heated in order to transfer the received heat to at least one substance being present in an internal volume as comprised by the receptacle, by which process the receptacle inevitably generates and spatially distributes a portion of the thermal radiation to an external volume surrounding the receptacle. In general, the at least one piece of cookware may be selected from a pot or a pan; however a further piece of cookware may also be feasible. In general, the at least one piece of cookware can be used in at least one of a household, a canteen kitchen, or an industrial kitchen; however, it may also be feasible to use them in a further environment, such as in a laboratory. Specifically, at least a partition of the radiation emitting element may emit a predominant portion of the thermal radiation, wherein the partition may, more specifically, be selected from a bottom part of the radiation emitting element being placed at the at least one transition material in an adjacent fashion.

In general, the thermal radiation of the at least one piece of cookware may be determined in an arrangement in which the at least one piece of cookware may be located on top of a cooktop, in particular a ceramic glass cooktop. However, the at least one radiation emitting element may, also, be or comprise at least one further object that may, accidentally or deliberately, assume the location of the at least one piece of cookware on top of the cooktop, specifically in order to be able to detect a presence of the at least one further object that may constitute a potential fire hazard on top of the cooktop and to prevent an operation of the cooktop in this event. By way of example, at least one further object may be or comprise a plastic container or a burn stain which is located on the ceramic glass cooktop. However, further objects may also be feasible.

As further used herein, the term “intensity” with respect to the thermal radiation refers to a power of a radiant flux as emitted per unit area by the radiation emitting element. The intensity may, in a particular for a black radiation emitting element, be represented by a spectral, wherein the term “spectral radiance” refers to the radiant flux emitted by the radiation emitting element per unit solid angle, per unit area, and per wavelength. Herein, the spectral radiance indicates how much of a power emitted by the black radiation emitting element can actually be received at a particular wavelength by a radiation sensitive element viewing the radiation emitting element from a specified angle of view. However, for further kinds of radiation emitting element, a different measure for the intensity of the thermal radiation may be appropriate. As further used herein, the term “value” refers to a numerical representation of the intensity of the thermal radiation.

As already indicated above, the device according to the present invention is designated for monitoring the emission temperature of the at least one radiation emitting element. As generally used, the term “emission temperature” refers to a temperature at which the at least one radiation emitting element is generating the corresponding thermal radiation. As particularly known to the person skilled in the art, a distribution of the intensity of the thermal radiation over a wavelength depends on the emission temperature. In the particular example of the black radiation emitting element as presented above, the spectral radiance of the radiation emitting element for the wavelength at the emission temperature follows Planck's law. However, for other kinds of radiation emitting elements, the distribution of the intensity of the thermal radiation over the wavelength, in general, also depends on the corresponding emission temperature.

As further generally used, the term “monitoring” or any grammatical variation thereof refers to a process of determining at least one piece information from at least one piece of data which may, in particular, be continuously acquired data, without user interaction, wherein the term “measuring” relates to a process of continuously acquiring the data without user interaction. For this purpose, a plurality of sensor signals may be generated and evaluated, from which the at least one piece of information can be determined. In particular, the plurality of the sensor signals may be recorded and/or evaluated within at least one of a fixed time interval or a variable time interval or, alternatively or in addition, upon an occurrence of at least one prespecified event, such as a presence of at least one further object that may, accidentally or deliberately, be detected as described below in more detail.

The device comprises at least one light source. As used herein, the term “light source” refers to a device or element configured for emitting optical radiation, specifically in at least one of the optical spectral range and the infrared spectral range. Thus, the at least one light source may be configured to provide sufficient emission in a desired spectral range, preferably in the optical spectral range and/or the infrared spectral range or at least one selected partition thereof. The at least one light source may, in particular, be comprised by at least one of a thermal radiator or a semiconductor-based radiation source. Herein, the semiconductor-based radiation source may, especially, be selected from at least one of a light emitting diode (LED) or a laser, in particular a laser diode. Further, the thermal radiator may, especially, be selected from at least one of an incandescent lamp or a thermal infrared emitter. Thus, the light source may be or comprise an incandescent lamp or a thermal infrared emitter. As further used herein, the term “thermal infrared emitter” refers to a micro-machined thermally emitting device which comprises a radiation emitting surface as the radiation emitting element that emits the optical radiation to be monitored. Specifically, thermal infrared emitters are available as “emirs50” from Axetris AG, Schwarzenbergstrasse 10, CH-6056 Kägiswil, Switzerland, as “thermal infrared emitters” from LASER COMPONENTS GmbH, Werner-von-Siemens-Str. 15 82140 Olching, Germany, or as “infra-red emitters” from Hawkeye Technologies, 181 Research Drive #8, Milford CT 06460, United States. However; further types of light sources may also be feasible.

The at least one light source may be a continuous light source or, alternatively, a pulsed light source, wherein the pulsed light source may have a modulation frequency of at least 1 Hz, of at least 5 Hz, of at least 10 Hz, of at least 50 Hz, of at least 100 Hz, of at least 500 Hz, of at least 1 kHz, or more. For driving the pulsed light source, a modulation device can be used, which may be designated for modulating the illumination, preferably by generating a periodic modulation. As generally used, the term “modulation” refers a process in which a total power of the illumination is varied, preferably periodically, in particular with at least one modulation frequency. In particular, a periodic modulation can be effected between a maximum value and a minimum value of the total power of the illumination. The minimum value can be 0, but can also be >0, such that, by way of example, complete modulation does not have to be effected. The modulation can, preferably, be effected within the radiation source designated for generating the desired modulated illumination, preferably, by the at least one radiation emitting element itself having a modulated intensity and/or total power, for example a periodically modulated total power, and/or by the at least one radiation emitting element being embodied as a pulsed radiation source, for example as a pulsed laser. As a further example, WO 2021/110721 A1 discloses at least one light source or radiation emitting element which is designated for generating optical radiation upon being heated by an electrical current; a mount, wherein the mount carries the at least one radiation emitting element, and wherein the mount or a portion thereof is movable; and a heat sink, wherein the heat sink is designated for cooling the mount and the at least one radiation emitting element being carried by the mount upon being touched by the mount. Alternatively or additionally, a different type of modulation device, for example, a modulation device based on an electro-optical effect and/or an acousto-optical effect, can also be used. Further, at least one of a periodic beam interrupting device, in particular a beam chopper, an interrupter blade or an interrupter wheel, can also be used.

For a purpose of monitoring the emission temperature of the at least one radiation emitting element, the device comprises at least one radiation sensitive element. As used herein, the “radiation sensitive element” refers to a device which is designated for generating at least one sensor signal in a manner dependent on a reception of radiation by the radiation sensitive element or a part thereof. As further used herein, the term “sensor signal” refers to an electrical signal which is generated by the at least one radiation sensitive element upon irradiation by the radiation. Herein, the sensor signal may be or may comprise a digital and/or an analog signal. In particular, the sensor signal may be or may comprise a voltage signal and/or a current signal. Additionally or alternatively, the sensor signal may be or may comprise digital data. The sensor signal may comprise a single signal value and/or a series of signal values. The sensor signal may, further, comprise an arbitrary signal which can be generated by combining at least two individual signals, in particular by averaging at least two signals and/or by forming a ration of at least two signals.

As already indicated above, the at least one radiation sensitive element is selected from a radiation sensor having at least one sensor region. As used herein, the term “sensor region” refers to a portion of the at least one radiation sensitive element which is designated for receiving radiation in a manner that a generation of the at least one sensor signal may be triggered, wherein the generation of the sensor signal may be governed by a defined relationship between the sensor signal and the manner of the illumination of the sensor region. Herein, the sensor region may be a uniform sensor region or, as an alternative, comprise a radiation sensitive array which may be partitioned into a plurality of radiation sensitive pixels. The at least one sensor signal may be generated in a manner dependent on an intensity of the thermal radiation as emitted by the at least one radiation emitting element and as received by the sensor region, wherein the sensor signal may be an arbitrary signal being indicative of the intensity of the incident thermal radiation illuminating the sensor region.

For a purpose of generating the sensor signal upon illumination, the sensor region comprises a photosensitive material, wherein the photosensitive material is selected from a photoconductive material. As used herein, the term “photoconductive material” refers to a material which is capable of sustaining an electrical current, thus exhibiting a specific electrical conductivity, wherein, specifically, the electrical conductivity is dependent on the illumination of the material. In this kind of material, the electrical current may be guided via at least one first electrical contact through the material to at least one second electrical contact, or vive-versa. For this purpose, at least two individual electrical contacts may be applied at different locations of the sensor region, especially in a fashion that the first electrical contact and the second electrical contact are electrically isolated with respect to each other while each of the first electrical contact and the second electrical contact are in direct connection with the sensor layer. For this purpose, the electrical contacts may comprise an evaporated metal layer which can easily be provided by using at least one known evaporation technique. In particular, the evaporated metal layer may comprise at least one of gold, silver, aluminum, platinum, magnesium, chromium, or titanium. Alternatively, the electrical contacts may comprise a layer of graphene.

The at least one photoconductive material may, preferably, comprise at least one chalcogenide, wherein the at least one chalcogenide may, preferably, be selected from a sulfide chalcogenide or a selenide chalcogenide, a solid solution and/or a doped variant thereof. As used herein, the term “solid solution” refers to material in which at least one solute is comprised in a solvent, whereby a homogeneous phase is formed and wherein the crystal structure of the solvent is, generally, unaltered by the presence of the solute. By way of example, binary PbSe may be solved in PbS leading to PbS₁₋ₓSeₓ, wherein x can vary from 0 to 1. As further used herein, the term “chalcogenide” refers to a compound which comprises at least one group 16 element of the periodic table apart from an oxide, i.e. a sulfide, a selenide, and a telluride. In a particularly preferred embodiment, the at least one layer of at least one photoconductive material may, especially, lead sulfide (PbS) for a wavelength of 0.8 μm to 2.8 μm, or lead selenide (PbSe) for a wavelength of 0.8 μm to 5 μm. However, other inorganic photoconductive materials may also be feasible.

According to the present invention, the at least one sensor region is designated for generating the at least one sensor signal depending on the intensity of the thermal radiation as emitted by the at least one radiation emitting element and received by the sensor region within the at least one wavelength range. In addition, the at least one sensor region is designated for generating at least one further sensor signal depending on the intensity of the optical radiation as emitted by the at least one light source and received by the sensor region within at the least one further wavelength range. The at least one wavelength range of the thermal radiation may, partially or completely, comprise the at least one further wavelength range of the optical radiation, or vice versa. In a specific embodiment, the at least one wavelength range and the at least one further wavelength range may be identical. As used herein, the term “wavelength range” refers to an interval of wavelengths of the radiation from which the at least one sensor signal is generated.

As described above, the at least one sensor signal may, in general, be generated for the at least one wavelength range in an individual fashion. In an alternative embodiment, the at least one sensor signal may, however, only be generated by using at least one known value for the intensity of the thermal radiation. In this fashion, a measuring time may be reduced. As a further alternative, the at least one known value may be used in case an invalid value or no value can, currently, be determined in the at least one wavelength range, in which event the at least one evaluation unit can use the at least one known value as a fallback opportunity, thus, still being able to generate at least one valid value for the emission temperature at any time. Analogously, the at least one further sensor signal may, in general, be generated for the at least one further wavelength range in an individual fashion. In an alternative embodiment, the at least one further sensor signal may, however, only be generated by using at least one known value for the intensity of the optical radiation. In this fashion, a measuring time may be reduced. As a further alternative, the at least one known value may be used in case an invalid value or no value can, currently, be determined in the at least one further wavelength range, in which event the at least one evaluation unit can use the at least one known value as a fallback opportunity, thus, still being able to generate at least one valid value for the emission temperature at any time.

Further according to the present invention, the at least one radiation sensitive element is arranged in a manner that the thermal radiation travels through at least one transition material before it is received by the at least one radiation sensitive element. As used herein, the term “transition material” refers to a material which is located in the optical path of the thermal radiation to be traversed by the thermal radiation before the thermal radiation irradiates the at least one radiation sensitive element. In particular, the at least one transition material may be selected from at least one ceramic material, specifically at least one ceramic material as, typically, used in a ceramic glass cooktop. In particular, the at least one transition material may be mechanically strong to be able carry the at least one piece of cookware. Further, the at least one transition material may be heat-insensitive to be able to sustain repeated and/or rapid temperature alterations. Further, the at least one transition material may have a considerably low heat conduction coefficient to remain at ambient temperature outside a cooking zone designated for receiving the at least one piece of cookware. Further, the at least one transition material may be at least partially transparent for the thermal radiation and the optical radiation, it may, however, not be transparent or only “partially transparent for the thermal radiation and/or the optical radiation in at least one further wavelength range, specifically selected from of above 2.8 μm to 3.2 μm. As used herein, the term “partially transparent” refers to a transparency for the thermal radiation of the at least one transition material of, preferably, not more than 10%, more preferred of not more than 2%, in particular of not more than 1%.

Preferably, the at least one ceramic material as used for the present invention may be selected from an LAS system, wherein the term “LAS system” denotes a mixture of lithium oxide, silicon oxide, aluminum oxide, and at least one additional component, especially selected from at least one glass-phase-forming agent, such as sodium oxide, potassium oxide, or calcium oxide, refining agent and/or nucleation agent, such as a mixture of zirconium(IV) oxide and titanium(IV) oxide. A particular kind of such material is known under CERAN®. However, further kinds of ceramic materials may also be feasible.

Further according to the present invention, at least one of the at least one light source and the at least one radiation sensitive element is arranged in a manner that the optical radiation travels through the at least one transition material and impinges the at least one radiation emitting element prior to being received by the at least one radiation sensitive element. As an example, the light source may be positioned and/or aligned such that the light source emits optical radiation at least partially towards the radiation emitting element from which the optical radiation may be reflected at least partially towards the radiation sensitive element. Thus, the radiation sensitive element may be positioned and/or aligned such that the radiation sensitive element at least partially receives the reflected optical radiation from the radiation emitting element. Further options may be feasible.

Further, the device according to the present invention comprises at least one evaluation unit. As used herein, the term “evaluation unit” generally refers to an arbitrary device which is designed for generating at least one piece of information based on measured data. More particular, the evaluation unit according to the present invention is designated for determining wherein the at least one evaluation unit is configured to determine the emission temperature of the at least one radiation emitting element by using values for the intensity of the thermal radiation and the optical radiation, wherein the values for the intensity of the thermal radiation and the optical radiation are acquired by the at least one radiation sensitive element and transferred to the evaluation unit. For this purpose, the evaluation unit may be or comprise one or more integrated circuits, such as one or more application-specific integrated circuits (ASICs), and/or one or more digital signal processors (DSPs), and/or one or more field programmable gate arrays (FPGAs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. Further, the evaluation unit may comprise one or more data storage devices. Further, the evaluation unit may comprise one or more interfaces, such as one or more wireless interfaces and/or one or more wire-bound interfaces.

In a preferred embodiment, the at least one evaluation unit is further configured to determine an emissivity of the at least one radiation emitting element. As used herein, the term “emissivity” relates to an effectivity of the at least one radiation emitting element to emit thermal radiation. More particular, the emissivity refers to a material property of the at least one radiation emitting element by which the intensity of the thermal radiation that is emitted by the at least one radiation emitting element. In general, the emissivity is indicated by a value of 0 to 1, wherein the value of 1 corresponds to a surface of a perfect black body that emits thermal radiation in accordance with Planck's law, wherein the emissivity of the at least one radiation emitting element, usually, assumes a value below 1 but above 0, typically above 0.5, more typically, above 0.8, preferably above 0.9. Specifically, the at least one evaluation unit may be configured to determine the emissivity of the at least one radiation emitting element as a function of the at least one further sensor signal depending on an intensity of the optical radiation emitted by the at least one light source, the at least one further sensor signal being generated by the at least one radiation sensitive element. Optical properties, specifically spectral properties, of the optical radiation may be predetermined by using the light source. Specifically, the light source may emit a known spectrum at least partially towards the radiation emitting element. Thus, a variation of the optical radiation induced by an interaction with the radiation emitting element can be determined. Such a variation may, specifically, be related to the emissivity of the radiation emitting element. In other words, the determined variation of the optical radiation may, specifically, be related to the emissivity of the radiation emitting element. Thus, the emissivity of the radiation emitting element can be represented by a function of the further sensor signal. The function may, specifically, consider initial optical properties of the optical radiation as emitted by the light source before interaction with the radiation emitting element.

In a further preferred embodiment, the device according to the present invention may, in addition, comprise at least one further radiation sensitive element, wherein the at least one further radiation sensitive element may be designated for generating at least one still further sensor signal which depends on the intensity of further thermal radiation as emitted by the at least one transition material within at least one still further wavelength range. For further details, concerning the terms “further radiation sensitive element”, “still further sensor signal”, or “still further wavelength range”, the definitions of the terms “radiation sensitive element”, “sensor signal” or “wavelength range”, respectively, may mutatis mutandis be applicable. In this further preferred embodiment, the at least one transition material may be transparent for the thermal radiation that is emitted by the radiation emitting element within the at least one still further wavelength range not at all or only to a partial extent. For the term “partially transparent”, reference may be made to the definition as provided above.

In a particularly preferred embodiment, the at least one wavelength range and/or the at least one further wavelength range may be selected from at least one wavelength above 2.8 μm to 3.2 μm, specifically in a case in which the at least one layer of the at least one photoconductive material as comprised by the at least one sensor region of the at least one radiation sensitive element may, especially, comprise lead sulfide (PbS) which is sensitive in a wavelength range of 0.8 μm to 2.8 μm. In this particularly preferred embodiment, at least one PbS comprising radiation sensitive element may be used for determining the intensity of the thermal radiation and/or the optical radiation within the at least one wavelength range and/or the at least one further wavelength range selected from a wavelength of 0.8 μm to 2.8 μm, whereas the at least one further radiation sensitive element may be selected to be sensitive in the still further wavelength range selected from a wavelength above 2.8 μm to 3.2 μm, while the at least one PbS comprising radiation sensitive element is insensitive to incident thermal radiation and/or incident optical radiation having a wavelength in the further wavelength range.

In this further preferred embodiment, the at least one evaluation unit may, further, be configured to take into account the at least one still further sensor signal as measured by the at least one further radiation sensitive element when determining the emission temperature of the at least one radiation emitting element. For this purpose, the at least one evaluation unit may, further, be configured to correct the intensity of the thermal radiation and/or the optical radiation by removing a contribution of the intensity of further thermal radiation that may be emitted by the at least one transition material from the intensity of the thermal radiation as emitted by the at least one radiation emitting element and/or the optical radiation as emitted by the at least one light source, respectively. In this fashion, a more appropriate result for the share of the thermal radiation which is emitted only by the at least one radiation emitting element and/or the optical radiation which is emitted only by the at least one light source could be obtained in a reproducible manner which is capable of taking into account any alterations of the contribution of the further thermal radiation that may be emitted by the at least one transition material.

In a further preferred embodiment, the device according to the present invention may, in addition, comprise at least one temperature sensor, wherein the at least one temperature sensor may be designated for monitoring a temperature of the at least the at least one radiation sensitive element and/or the at least one transition material. As generally used, the term “temperature sensor” refers to an arbitrary kind of sensor which is designated for generating at least one sensor signal from which a temperature can be derived. In particular, the at least one temperature sensor may be selected from at least one of a thermoelectric sensor, a thermistor, a thermocouple, a resistance temperature detector (RTD), a semiconductor based integrated circuit configured to determine at least one temperature by using at least one physical property of at least one transistor. However, a further kind of temperature sensor may also be feasible. Preferably, the at least one temperature sensor designated for monitoring the temperature of the at least one radiation sensitive element may be located in a vicinity of at least one of the at least one radiation sensitive element. Further preferred, the at least one temperature sensor designated for monitoring the temperature of the at least one transition material may be designed for monitoring the temperature of a portion of the at least one transition material which is passed by an optical path between the at least one radiation emitting element and the at least one radiation sensitive element. Further, the at least one evaluation unit may, in addition, be configured to take into account the temperature as measured by the at least one temperature sensor when determining the emission temperature of the at least one radiation emitting element. In this fashion, a contribution of the at least one radiation sensitive element and/or of the at least one transition material to the at least one sensor signal as generated by the at least one radiation sensitive element can be considered and, preferably, be removed from the at least one sensor signal as generated by the at least one radiation sensitive element.

In a further preferred embodiment, the device according to the present invention may, in addition, comprise at least one reference radiation sensitive element, wherein the at least one reference radiation sensitive element has at least one covered sensor region. Preferably, the at least one covered sensor region may comprise the same photosensitive material as the at least one radiation sensitive element in order to facilitate a comparison between reference signals as generated by the at least one the covered sensor region of the at least one reference radiation sensitive element with the sensor signals as generated by the at least one sensor region of the at least one radiation sensitive element. As used herein, the term “covered” refers to a particular arrangement of the at least one reference radiation sensitive element which impedes that the reference radiation sensitive element may receive the thermal radiation as emitted by the at least one radiation emitting element. For this purpose, the at least one covered sensor region can be covered by using a radiation absorptive layer which may be designed to absorb the thermal radiation and/or the optical radiation and/or a radiation reflective layer which may be designed to reflect the thermal radiation and/or the optical radiation. Further, the at least one evaluation unit may, in addition, be configured to take into account the at least one reference signal when determining the emission temperature of the at least one radiation emitting element. In this fashion, an alteration of the at least one radiation sensitive element over a period of time can be considered and, preferably, be removed from the at least one sensor signal as generated by the at least one radiation sensitive element.

In a further preferred embodiment, the device according to the present invention may, in addition, comprise at least one presence sensor. As used herein, the term “presence sensor” refers to an arbitrary kind of sensor which is designated for generating at least one sensor signal from which information about an occupancy of a radiation path in front of the at least one photosensitive region in at least one predefined range can be determined. The presence sensor may further be designated for generating at least one sensor signal from which a distance from the presence sensor can be derived. In particular, the at least one presence sensor may be selected from the group consisting of a time-of flight sensor, a distance sensor, a proximity sensor, an ultrasonic sensor, an optical sensor, an inductive sensor, a tactile sensor, a radar sensor, a triangulation sensor, a stereo sensor, a structured light sensor, a capacitive sensor, a FIP sensor, a BPA sensor, as known to the person skilled in the art. Herein, the at least one presence sensor may, preferably, be configured to determine at least one further object which can be located in a manner that the thermal radiation may travel through the at least one further object before it may be received by the at least one radiation sensitive element, thus, influencing the at least one sensor signal as generated by the at least one radiation sensitive element. In particular, the at least one further object may not be transparent in at least one of the at least one wavelength range of the radiation emitting element and the at least one further wavelength range of the optical radiation, thereby reducing the at least one sensor signal as generated by the at least one radiation sensitive element. More particular, the at least one further object may be selected from a plastic container and/or a burn stain that may be located on the ceramic glass cooktop. By using the at least one presence sensor and arranging the at least one presence sensor to a distance between the at least one presence sensor and the surface of the ceramic glass cooktop which is easily accessible from outside the heating system, a presence of the at least one further object can be considered. As described below in more detail, at least one notification, such as at least one warning, could be provided to a person using the heating system at an occurrence of such an event.

In a further preferred embodiment, the device according to the present invention may, in addition, comprise at least one thermoelectric cooler. The thermoelectric cooler may, in particular, be configured to cool at least the at least one radiation sensitive element. As used herein, the term “thermoelectric cooler” refers to an electrically driven heat pump which is designated for transferring heat between at least two spatial areas, thereby generating a heat flux between the at least two spatial areas. The thermoelectric cooler may, specifically, be based on the Peltier effect in order to create the heat flux. For this purpose, the thermoelectric cooler may, especially, comprise at least one Peltier element. A direction of the heat flux may depend on a direction of an electrical current applied to the thermoelectric cooler. Depending on the direction of the heat flux, the thermoelectric cooler can be used for cooling at least one spatial area by transferring heat to at least one further spatial area, or for heating the at least one spatial area by transferring heat from the at least one further spatial area. However, further kinds of the thermoelectric cooler may also be feasible.

In a further preferred embodiment, the device according to the present invention may further comprise at least one optical radiation shielding. As used herein, the term “optical radiation shielding” refers to an element configured for shielding or covering an object from direct optical radiation. Thus, the optical radiation shielding may at least partially cover the object such that the objected cannot be illuminated directly. The optical radiation shielding may, specifically, be configured for allowing indirect optical radiation, e.g. reflected optical radiation, to impinge the object. The optical radiation shielding may comprise at least one solid material absorbing and/or reflecting the optical radiation, e.g. a synthetic plastic material or a metal. Specifically, the optical radiation shielding may be configured to shield the at least one radiation sensitive element from being directly illuminated by the optical radiation emitted by the at least one light source. Additionally or alternatively, the optical radiation shielding may be configured to shield the at least one further radiation sensitive element from being directly illuminated by the optical radiation emitted by the at least one light source.

In a further aspect of the present invention, a heating system for heating at the least one radiation emitting element to emit thermal radiation at an emission temperature is disclosed. According to the present invention, the heating system comprises:
at least one device for monitoring an emission temperature of at least one radiation emitting element, wherein the at least one radiation emitting element emits thermal radiation at the emission temperature;
at least one transition material, wherein the at least one transition material is arranged in a manner that the thermal radiation and the optical radiation travel through the at least one transition material prior to being received by the at least one radiation sensitive element, wherein the at least one transition material is at least partially transparent for the thermal radiation and the optical radiation;
at least one heating unit, wherein the at least one heating unit is designated for heating the at the least one radiation emitting element via the at least one transition material; and
at least one control unit, wherein the at least one control unit is designated for controlling an output of the at least one heating unit based on the emission temperature of the at least one radiation emitting element determined by the device for monitoring the emission temperature of at least one radiation emitting element.

As generally used, the term “system” refers to a plurality of spatial entities comprising at least the above-listed components. Herein, each of the listed components may be separate components, however, two or more but not all of the components may be integrated into a common component. Herein, the heating system comprises the device for monitoring an emission temperature of at least one radiation emitting element as described above and below in more detail. In particular, the heating system may be or comprise at least one of an electric cooktop or an induction cooktop for use in a household, a canteen kitchen, or an industrial kitchen, wherein the at the least one radiation emitting element may be selected from at least one piece of cookware, and wherein the at least one transition material may be selected from at least one ceramic material used in a ceramic glass cooktop. However, further kinds of heating systems may also be feasible, in particular a laboratory heating system or an industrial heating machine for hardening, tempering, brazing, welding, annealing, preheating, post-heating, shrink fitting, bolt heating, forging and/or melting. Further kinds of heating systems may be used for semiconductor wafer production and similar applications, where the radiation sensitive element should be separated from the heating unit by means of the transition material to protect the radiation sensitive element and its electronics from harsh environmental conditions, such as high temperatures, vacuum or corrosive gases.

As used herein, the term “heating” or any grammatical variation thereof refers to a process of increasing a temperature of at least one object, in particular the at the least one radiation emitting element, preferably the at least one piece of cookware. As further used herein, the term “heating unit” refers to an arbitrary entity which is designated for heating the at the least one radiation emitting element, preferably the at least one piece of cookware, via the at least one transition material, preferably at least one ceramic material as used in a ceramic glass cooktop. In a particularly preferred embodiment, the at least one heating unit may comprise at least one heating element having at least one opening which may, preferably, be designated in a manner that the thermal radiation as emitted by the at least one radiation emitting element and the optical radiation as emitted by the at least one light source can travel through the at least one opening in order to impinge on the at least one sensor region of the at least one radiation sensitive element. Preferably, the at least one heating element may be or comprise at least one induction coil and/or at least one infrared halogen lamp; however, further kinds of at heating elements may also be feasible. Herein, the at least one induction coil may be designed for heating the least one radiation emitting element, preferably the at least one piece of cookware, by using thermal heat and/or electromagnetic induction.

In a particularly preferred embodiment, the heating system may, in addition, comprise at least one heat shielding. As used herein, the term “heat shielding” refers to an arbitrary entity which is designated for retaining the thermal radiation as generated by the at least one heating unit, in particular, the at least one heating element from impinging the device for monitoring the emission temperature of the at least one radiation emitting element, specifically the radiation sensitive element. For this purpose, the heat shielding may, preferably, be designed for shielding the at least one device for monitoring the emission temperature of the at least one radiation emitting element, specifically the at least one radiation sensitive element, from the at least one heating unit. Preferably, the at least one heat shielding can comprise at least one aperture that may be designated in a manner that the thermal radiation emitted by the at least one radiation emitting element and the optical radiation emitted by the at least one light source travels through the at least one aperture. In this fashion, the thermal radiation as emitted by the at least one radiation emitting element can travel along the optical path to the at least one radiation sensitive element, thereby avoiding that a portion of the thermal radiation may be absorbed by the heat shielding.

As further used herein, the term “control unit” refers to an arbitrary entity which is designated for controlling an output of the at least one heating unit. According to the present invention, the at least one control unit is configured to control the output of the at least one heating unit based on the emission temperature of the at least one radiation emitting element as determined by using the device for monitoring the emission temperature of at least one radiation emitting element. In this fashion, the emission temperature of the at least one radiation emitting element, in particular of the at least one piece of cookware, can be adjusted to a predefined value, preferably in an automatic manner.

In addition, the heating system may, further, comprise at least one setting element. As used herein, the term “setting element” refers to an arbitrary entity which is configured to receive at least one piece of information as inputted by at least one user of the heating system. In this fashion, the at least one user of the heating is capable to set the emission temperature of the at least one radiation emitting element, in particular of the at least one piece of cookware, to a desired value. In a preferred embodiment, the desired value can overwrite the predefined value as, preferably, adjusted in an automatic manner by using the at least one control unit, or-vice versa. However, further kinds of adjusting the emission temperature of the at least one radiation emitting element, in particular of the at least one piece of cookware, may also be feasible, whereby one or both of the desired value and the predefined value can be taken into account, in particular, depending on a preselected procedure.

In addition, the heating system may, further, comprise at least one notification unit. As generally used, the term “notification unit” refers to an arbitrary entity which is configured to provide at least one further piece of information to the at least one user of the heating system, preferably in at least one of a visual, an acoustic or a tactile fashion. In particular, the at least one notification unit may be configured to provide information about at least one of
an actual value of the emission temperature of the at least one radiation emitting element, in particular of the at least one piece of cookware, as determined by using the device as described herein;
at least one desired value for the emission temperature;
at least one predefined value for the emission temperature;
at least one notification, preferably at least one warning at an occurrence of at least one event, in particular selected from
   a presence of the at least one further object that may, accidentally or deliberately, assume the location of the at least one piece of cookware on top of the cooktop, such as a plastic container or a burn stain, and that may constitute a potential fire hazard on top of the cooktop;
   an unexpectedly rapid change of the emission temperature, which may indicate a complete evaporation of a content of the at least one radiation emitting element, in particular the at least one piece of cookware, which may lead to overheating;
   a rapid change in an emission value of the at least one radiation emitting element, in particular the at least one piece of cookware, which may indicate boiling over, and/or
that an operation of the cooktop is prevented due to the occurrence of the at least one event

to the user of the heating system.

Preferably, the at least one heating system may be arranged in a fashion that the at least one transition material may comprise at least one cooking zone, preferably, two, three, four, five, six or more, individual cooking zones, which can, preferably, be controlled in an independent fashion with respect to each other. In a particularly preferred embodiment, an individual heating unit, an individual setting element and an individual device for monitoring an emission temperature of at least one radiation emitting element, wherein the at least one radiation emitting element emits thermal radiation at the emission temperature may, preferably, be provided for each cooking zone, whereas the at least one control unit and the at least one notification unit may each be provided as a single unit for all cooking zones. In an alternatively preferred embodiment, at least one optical element may be used, wherein the at least one optical element may be designated to direct the thermal radiation as received from at least two individual cooking zones to a single device for monitoring an emission temperature of at least one radiation emitting element configured to such a purpose, in particular by being configured to apply a multiplexing procedure for monitoring the emission temperatures of at least two radiation emitting elements which may be placed on at least two individual cooking zones. However, further arrangements may also be feasible.

For further details concerning the heating system, reference may be made to the device for monitoring an emission temperature of at least one radiation emitting element as described above or below in more detail.

In a further aspect of the present invention, a method for monitoring an emission temperature of at least one radiation emitting element, wherein the at least one radiation emitting element emits thermal radiation at the emission temperature is disclosed. The method comprises the following steps, which may, preferably, be performed in the given order. Herein, the steps may be performed in an overlapping fashion in time. In addition, the method may comprise further steps which can be described herein or not. Accordingly, the method comprises the steps of:
generating at least one sensor signal by using at least one radiation sensitive element, wherein the at least one radiation sensitive element has at least one sensor region, wherein the at least one sensor region comprises a photosensitive material selected from a photoconductive material, wherein the at least one sensor region is designated for generating the at least one sensor signal depending on an intensity of the thermal radiation emitted by the at least one radiation emitting element and received by the sensor region within at least one wavelength range, wherein the at least one radiation sensitive element is arranged in a manner that the thermal radiation travels through at least one transition material prior to being received by the at least one radiation sensitive element;
emitting optical radiation at least partially towards the at least one radiation emitting element by using the at least one light source;
generating at least one further sensor signal by using the at least one radiation sensitive element, wherein the sensor region is further designated for generating the at least one further sensor signal depending on an intensity of the optical radiation emitted by the at least one light source and received by the sensor region within at least one further wavelength range; and
determining the emission temperature of the at least one radiation emitting element by evaluating the sensor signals of the at least one radiation sensitive element by using the at least one evaluation unit, wherein the at least one evaluation unit is configured to determine the emission temperature of the at least one radiation emitting element by using values for the intensity of the thermal radiation and the optical radiation.

Preferably, the method may, further, comprise at least one of the following steps of:
generating at least one further sensor signal depending on the intensity of further thermal radiation emitted by the at least one transition material within at least one still further wavelength range, wherein the at least one transition material is not transparent or only partially transparent for the thermal radiation emitted by the radiation emitting element within the at least one still further wavelength range;
determining the emission temperature of the at least one radiation emitting element by taking into account the at least one further sensor signal when determining the emission temperature of the at least one radiation emitting element;
generating at least one reference signal by using at least one reference radiation sensitive element, wherein the at least one reference radiation sensitive element has at least one covered sensor region, wherein the at least one covered sensor region comprises the same photosensitive material as the at least one radiation sensitive element and is being covered in a manner to impede that the reference radiation sensitive element receives the thermal radiation emitted by the at least one radiation emitting element;
determining the emission temperature of the at least one radiation emitting element by taking into account the at least one reference signal when determining the emission temperature of the at least one radiation emitting element;
determining an emissivity of at least one material comprised by the at least one radiation emitting element by using the emission temperature of the at least one radiation emitting element.

In a further aspect of the present invention, a method for heating at the least one radiation emitting element to emit thermal radiation at an emission temperature is disclosed. The method comprises the following steps, which may, preferably, be performed in the given order. Herein, the steps may be performed in an overlapping fashion in time. In addition, the method may comprise further steps which can be described herein or not. Accordingly, the method comprises the steps of:
monitoring an emission temperature of at least one radiation emitting element according to the method for monitoring an emission temperature of at least one radiation emitting element as described elsewhere herein, wherein the at least one radiation emitting element emits thermal radiation at the emission temperature;
controlling an output of at least one heating unit based on the emission temperature of the at least one radiation emitting element determined by the method for monitoring an emission temperature of at least one radiation emitting element according to any one of the preceding method Embodiments, wherein the at least one heating unit is designated for heating the at the least one radiation emitting element via at least one transition material, wherein the at least one transition material is arranged in a manner that the thermal radiation and the optical radiation travels through the at least one transition material prior to being received by the at least one radiation sensitive element.

In a particularly preferred embodiment, the controlling of the output of the at least one heating unit may, further, comprise determining a presence of at least one further object apart from the at least one radiation emitting element by using the emissivity of the at least one radiation emitting element. As described above or below in more detail, the at least one radiation emitting element may, preferably, be selected from at least one piece of cookware while the at least one further object may, in particular, be selected from at least one of a plastic container or a burn stain located on the ceramic glass cooktop.

In a particularly preferred embodiment, the controlling of the output of the at least one heating unit may, further, comprise determining a presence of a boil-dry condition in the at least one radiation emitting element after an aqueous liquid, such as water, has been completely evaporated. For this purpose, a temporal course of the emission temperature of the at least one radiation emitting element, in particular, of the at least one piece of cookware, may be used. It is known that, in general, the emission temperature of the at least one piece of cookware rapidly increases after the aqueous liquid has been completely evaporated. Based on a detection of a velocity by which the temperature of the at least one piece of cookware may increase, it is possible to determine the presence of a boil-dry condition in the at least one piece of cookware. Further, an operation of the at least one heating unit could be prevented after the presence of the boil-dry condition in the at least one radiation emitting element, particularly in the at least one piece of cookware, has been confirmed. Alternatively or in addition, at least one notification, such as at least one warning, may, preferably, be provided to the at least one user of the heating system.

For further details concerning the methods as used herein, reference may be made to the corresponding device or system as described above or below in more detail.

The devices and methods according to the present invention provide various advantages with respect to devices and methods as known from the prior art. The devices and methods are capable of monitoring in a simple and easy fashion a temperature of at least one object that emits thermal radiation, in particular within the infrared spectral range, specifically at least one piece of cookware, through at least one transition material, specifically a ceramic glass cooktop, that may, preferably, be arranged in a fashion that the thermal radiation travels through the at least one transition material before it can be received by at least one radiation sensitive element without being required to know an emissivity of the at least one object.

Spectral sensitivity range and high detectivity of a radiation sensitive element based on PbS in a wavelength range of interest may allow a measurement of the emission temperature without a need for an optical material having a high transmissivity, such as transparent quartz window. Such a window may require a hole in the transition material, specifically CERAN®, which may reduce the mechanical integrity of the heating system. Other detector technologies, such as pyroelectric detectors, thermopiles or bolometers, are much less sensitive in the same wavelength range and, thus, require a transparent window. Very sensitive detector technologies such as InGaAs cannot cover the wavelength range >2 μm.

The contribution of the transition material, specifically CERAN®, may be considered either by measuring the radiation by using a further radiation sensitive element at a third wavelength range or by measuring a temperature of the transition material using a temperature sensor and calculating the contribution at the first and second wavelength ranges. Thus, a temperature measurement through the transition material, specifically CERAN®, may be possible. Long-time and temperature drifts of detectors and electronics may be considered using the reference radiation sensitive element.

By sampling an emission spectrum of the radiation emitting element at at least two different wavelengths, a material dependency of a measurement due to different values for the emissivity may be removed. Since an emissivity or an emissivity dependent parameter of the radiation emitting element, specifically the piece of cookware, can be determined, any rapid changes in the emissivity may be detected, which may prevent a fire hazard due to for example boiling over of liquid, such as milk.

Compared to above mentioned detector technologies, PbS detectors are much faster. Since an emission temperature of the radiation emitting element may be monitored continuously using the present method, any rapid change in the emission temperature of the radiation emitting element may be detected, which may be an indication of complete evaporation of a content within the radiation emitting element, e.g. during cooking and boiling. Specifically, empty pans and pots can reach high temperatures very quickly, which may lead to overheating and cause a burning of a coating. The high temperatures may, further, cause a surface of the radiation emitting element to outgas fumes. They may further cause a warping and/or a denting of the radiation emitting element.

Further advantages are indicated throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restriction regarding the scope of the invention and without any restriction regarding the possibility of combining the features introduced in such a way with other optional or non-optional features of the invention.

Summarizing the above-mentioned findings, the following embodiments are preferred within the present invention:

Embodiment 1: A device for monitoring an emission temperature of at least one radiation emitting element, wherein the at least one radiation emitting element emits thermal radiation at the emission temperature, the device comprising
at least one light source, wherein the light source is configured to emit optical radiation at least partially towards the at least one radiation emitting element;
at least one radiation sensitive element, wherein the at least one radiation sensitive element has at least one sensor region, wherein the at least one sensor region comprises at least one photosensitive material selected from at least one photoconductive material, wherein the at least one sensor region is designated for generating at least one sensor signal depending on an intensity of the thermal radiation emitted by the at least one radiation emitting element and received by the sensor region within at least one wavelength range, wherein the sensor region is further designated for generating at least one further sensor signal depending on an intensity of the optical radiation emitted by the at least one light source and received by the sensor region within at least one further wavelength range, wherein the at least one radiation sensitive element is arranged in a manner that the thermal radiation travels through at least one transition material prior to being received by the at least one radiation sensitive element, wherein at least one of the at least one light source and the at least one radiation sensitive element is arranged in a manner that the optical radiation travels through the at least one transition material and impinges the at least one radiation emitting element prior to being received by the at least one radiation sensitive element; and
at least one evaluation unit, wherein the at least one evaluation unit is configured to determine the emission temperature of the at least one radiation emitting element by using values for the intensity of the thermal radiation and the optical radiation.

Embodiment 2: The device according to the preceding Embodiment, wherein the at least one light source is or comprises an incandescent lamp or a thermal infrared emitter, wherein the thermal infrared emitter is a micro-machined thermally emitting device which comprises a radiation emitting surface as a radiation emitting element.

Embodiment 3: The device according to any one of the preceding Embodiments, wherein the at least one photoconductive material comprises lead sulfide, wherein the at least one wavelength range and/or the at least one further wavelength range is selected from a wavelength of 0.8 μm to 2.8 μm.

Embodiment 4: The device according to any one of the preceding Embodiments, wherein the at least one photoconductive material comprises lead selenide, wherein the at least one wavelength range and/or the at least one further wavelength range is selected from a wavelength of 0.8 μm to 5 μm.

Embodiment 5: The device according to any one of the preceding Embodiments, wherein the at least one wavelength range of the thermal radiation is at least partially, preferably completely, comprised by the at least one further wavelength range of the optical radiation, or wherein the at least one further wavelength range of the optical radiation is at least partially, preferably completely, comprised by the at least one wavelength range of the thermal radiation.

Embodiment 6: The device according to any one of the preceding Embodiments, wherein the at least one further wavelength range of the optical radiation is identical with the at least one wavelength range of the thermal radiation.

Embodiment 7: The device according to any one of the preceding Embodiments, wherein the at least one transition material is selected from at least one ceramic material used in a ceramic glass cooktop.

Embodiment 8: The device according to any one of the preceding Embodiments, wherein the at least one evaluation unit is further configured to determine an emissivity of the at least one radiation emitting element, wherein the emissivity relates to an effectivity of the at least one radiation emitting element to emit the thermal radiation.

Embodiment 9: The device according to the preceding Embodiment, wherein the at least one evaluation unit is configured to determine the emissivity of the at least one radiation emitting element as a function of the at least one further sensor signal depending on an intensity of the optical radiation emitted by the at least one light source.

Embodiment 10: The device according to any one of the preceding Embodiments, further comprising
at least one further radiation sensitive element, wherein the at least one further radiation sensitive element is designated for generating at least one still further sensor signal depending on the intensity of further thermal radiation emitted by the at least one transition material within at least one still further wavelength range, wherein the at least one transition material is not transparent or only partially transparent for the thermal radiation emitted by the radiation emitting element within the at least one still further wavelength range of the further thermal radiation.

Embodiment 11: The device according to the preceding Embodiment, wherein the at least one evaluation unit is further configured to take into account the at least one still further sensor signal measured by the at least one further radiation sensitive element when determining the emission temperature of the at least one radiation emitting element.

Embodiment 12: The device according to the preceding Embodiment, wherein the at least one evaluation unit is further configured to correct the intensity of the thermal radiation by removing a contribution of the intensity of further thermal radiation emitted by the at least one transition material from the intensity of the thermal radiation emitted by the at least one radiation emitting element.

Embodiment 13: The device according to any one of the three preceding Embodiments, wherein the at least one still further wavelength range is selected from at least one wavelength of above 2.8 μm to 3.2 μm.

Embodiment 14: The device according to any one of the preceding Embodiments, further comprising
at least one temperature sensor, wherein the at least one temperature sensor is designated for monitoring a temperature in at least one of:
   the at least the one radiation sensitive element; or
   the at least one transition material,
wherein the at least one evaluation unit is further configured to take into account the temperature measured by the at least one temperature sensor when determining the emission temperature of the at least one radiation emitting element.

Embodiment 15: The device according to the preceding Embodiment, wherein the at least one temperature sensor is designated for monitoring the temperature of a portion of the at least one transition material which is passed by an optical path between the at least one radiation emitting element and the at least one radiation sensitive element.

Embodiment 16: The device according to any one of the preceding Embodiments, further comprising
at least one reference radiation sensitive element, wherein the at least one reference radiation sensitive element has at least one covered sensor region, wherein the at least one covered sensor region comprises the same photosensitive material as the at least one radiation sensitive element and is being covered in a manner to impede that the reference radiation sensitive element receives the thermal radiation emitted by the at least one radiation emitting element, wherein the at least one covered sensor region is designated for generating at least one reference signal,

wherein the at least one evaluation unit is further configured to take into account the at least one reference signal when determining the emission temperature of the at least one radiation emitting element.

Embodiment 17: The device according to the preceding Embodiment, wherein the at least one covered sensor region is being covered by at least one of:
a radiation absorptive layer designed to absorb the thermal radiation and the optical radiation; or
a radiation reflective layer designed to reflect the thermal radiation and the optical radiation.

Embodiment 18: The device according to any one of the preceding Embodiments, further comprising
at least one presence sensor, wherein the at least one presence sensor is configured to determine at least one further object which is located in a manner that the thermal radiation travels through the at least one further object prior to be received by the at least one radiation sensitive element.

Embodiment 19: The device according to the preceding Embodiment, wherein the at least one further object is not transparent or partially transparent in at least one of the at least one wavelength range of the thermal radiation emitted by the at least one radiation emitting element and the at least one further wavelength range of the optical radiation emitted by the at least one light source.

Embodiment 20: The device according to any one of the two preceding Embodiments, wherein the at least one further object is selected from at least one of a plastic container or a burn stain located on the ceramic glass cooktop.

Embodiment 21: The device according to any one of the three preceding Embodiments, wherein the at least one presence sensor is selected from at least one of a time-of-flight sensor, a distance sensor, a proximity sensor, an ultrasonic sensor, an optical sensor, an inductive sensor, a tactile sensor, a radar sensor, a triangulation sensor, a stereo sensor, a structured light sensor, a capacitive sensor, a FIP sensor, a BPA sensor.

Embodiment 22: The device according to any one of the preceding Embodiments, further comprising
at least one thermoelectric cooler configured to cool at least the at least one radiation sensitive element.

Embodiment 23: The device according to any one of the preceding claims, further comprising
at least one optical radiation shielding, wherein the optical radiation shielding is configured to shield the at least one radiation sensitive element and optionally the at least one further radiation sensitive element from being directly illuminated by the optical radiation emitted by the at least one light source.

Embodiment 24: A heating system for heating the at least one radiation mitting element to emit thermal radiation at an emission temperature, the system comprising:
at least one device for monitoring an emission temperature of at least one radiation emitting element according to any one of the preceding Embodiments, wherein the at least one radiation emitting element emits thermal radiation at the emission temperature;
at least one transition material, wherein the at least one transition material is arranged in a manner that the thermal radiation and the optical radiation travel through the at least one transition material prior to being received by the at least one radiation sensitive element, wherein the at least one transition material is at least partially transparent for the thermal radiation and the optical radiation;
at least one heating unit, wherein the at least one heating unit is designated for heating the at the least one radiation emitting element via the at least one transition material; and
at least one control unit, wherein the at least one control unit is designated for controlling an output of the at least one heating unit based on the emission temperature of the at least one radiation emitting element determined by the device for monitoring the emission temperature of at least one radiation emitting element.

Embodiment 25: The system according to preceding Embodiment, wherein the at least one heating unit comprises at least one heating element having at least one opening designated in a manner that the thermal radiation emitted by the at least one radiation emitting element and the optical radiation emitted by the at least one light source travel through the at least one opening.

Embodiment 26: The system according to the preceding Embodiment, wherein the at least one heating element is selected from at least one of an induction coil or at least one infrared halogen lamp, wherein the at least one induction coil is designed for heating the least one radiation emitting element by using at least one of thermal heat or electromagnetic induction.

Embodiment 27: The system according to any one of the preceding system Embodiments, further comprising
at least one heat shielding, wherein the at least one heat shielding is designated for shielding the at least one device for monitoring the emission temperature of the at least one radiation emitting element from the at least one heating unit, and wherein the at least one heat shielding comprises at least one aperture designated in a manner that the thermal radiation emitted by the at least one radiation emitting element and the optical radiation emitted by the at least one light source travel through the at least one aperture.

Embodiment 28: The system according to any one of the preceding system Embodiments, further comprising at least one of
at least one setting element configured to receive at least one piece of information inputted by at least one user of the heating system; or
at least one notification unit configured to provide at least one further piece of information to the at least one user of the heating system.

Embodiment 29: The system according to any one of the preceding system Embodiments, wherein
the at the least one radiation emitting element is selected from at least one piece of cookware; and
the at least one transition material is selected from at least one ceramic material used in a ceramic glass cooktop.

Embodiment 30: A method for monitoring an emission temperature of at least one radiation emitting element, wherein the at least one radiation emitting element emits thermal radiation at the emission temperature, the method comprising the following steps:
generating at least one sensor signal by using at least one radiation sensitive element, wherein the at least one radiation sensitive element has at least one sensor region, wherein the at least one sensor region comprises a photosensitive material selected from a photoconductive material, wherein the at least one sensor region is designated for generating the at least one sensor signal depending on an intensity of the thermal radiation emitted by the at least one radiation emitting element and received by the sensor region within at least one wavelength range, wherein the at least one radiation sensitive element is arranged in a manner that the thermal radiation travels through at least one transition material prior to being received by the at least one radiation sensitive element, wherein the at least one transition material is at least partially transparent for the thermal radiation within the at least one wavelength range;
emitting optical radiation at least partially towards the at least one radiation emitting element by using the at least one light source;
generating at least one further sensor signal by using the at least one radiation sensitive element, wherein the sensor region is further designated for generating the at least one further sensor signal depending on an intensity of the optical radiation emitted by the at least one light source and received by the sensor region within at least one further wavelength range; and
determining the emission temperature of the at least one radiation emitting element by evaluating the sensor signals of the at least one radiation sensitive element by using the at least one evaluation unit, wherein the at least one evaluation unit is configured to determine the emission temperature of the at least one radiation emitting element by using values for the intensity of the thermal radiation and the optical radiation.

Embodiment 31: The method according to the preceding Embodiment, wherein determining the emission temperature of the at least one radiation emitting element comprises using a single radiation sensitive element.

Embodiment 32: The method according to any one of the preceding method Embodiments, further comprising steps of
generating at least one still further sensor signal depending on the intensity of further thermal radiation emitted by the at least one transition material within at least one still further wavelength range, wherein the at least one transition material is not transparent or only partially transparent for the thermal radiation emitted by the radiation emitting element within the at least one still further wavelength range of the further thermal radiation;
determining the emission temperature of the at least one radiation emitting element by taking into account the at least one still further sensor signal when determining the emission temperature of the at least one radiation emitting element.

Embodiment 33: The method according to the preceding Embodiment, wherein determining the emission temperature of the at least one radiation emitting element comprises correcting the intensity of the thermal radiation by removing a contribution of the intensity of further thermal radiation emitted by the at least one transition material from the intensity of the thermal radiation emitted by the at least one radiation emitting element.

Embodiment 34: The method according to any one of the preceding method Embodiments, further comprising steps of
monitoring a temperature in at least one of:
   the at least the one radiation sensitive element; or
   the at least one transition material, and
determining the emission temperature of the at least one radiation emitting element by taking into account the monitored temperature when determining the emission temperature of the at least one radiation emitting element.

Embodiment 35: The method according to any one of the preceding method Embodiments, further comprising steps of
generating at least one reference signal by using at least one reference radiation sensitive element, wherein the at least one reference radiation sensitive element has at least one covered sensor region, wherein the at least one covered sensor region comprises the same photosensitive material as the at least one radiation sensitive element and is being covered in a manner to impede that the reference radiation sensitive element receives the thermal radiation emitted by the at least one radiation emitting element and the optical radiation emitted by the at least one light source; and
determining the emission temperature of the at least one radiation emitting element by taking into account the at least one reference signal when determining the emission temperature of the at least one radiation emitting element.

Embodiment 36: The method according to any one of the preceding method Embodiments, further comprising a step of
determining an emissivity of at least one material comprised by the at least one radiation emitting element by using the emission temperature of the at least one radiation emitting element.

Embodiment 37: The method according to any one of the preceding method Embodiments, comprising the following steps:
measuring the at least one sensor signal for the thermal radiation emitted by the radiation emitting element;
measuring a temperature drift and compensating the at least one sensor signal for the temperature drift;
further compensating the at least one sensor signal for at least one transition material through which the thermal radiation travels prior to being received by the at least one radiation sensitive element;
measuring at least one further sensor signal for the optical radiation emitted by the at least one light source;
measuring a temperature drift and compensating the at least one further sensor signal for the temperature drift;
further compensating the at least one further sensor signal for at least one transition material through which the optical radiation travels prior to being received by the at least one radiation sensitive element;
determining an emissivity of the at least one radiation emitting element as a function of the at least one further sensor signal depending on an intensity of the optical radiation;
determining the emission temperature of the at least one radiation emitting element by using the emissivity of the at least one radiation emitting element.

Embodiment 38: A method for heating the at least one radiation emitting element to emit thermal radiation at an emission temperature, the method comprising the following steps:
monitoring an emission temperature of at least one radiation emitting element according to any one of the preceding method Embodiments, wherein the at least one radiation emitting element emits thermal radiation at the emission temperature;
controlling an output of at least one heating unit based on the emission temperature of the at least one radiation emitting element determined by the method for monitoring an emission temperature of at least one radiation emitting element according to any one of the preceding method Embodiments, wherein the at least one heating unit is designated for heating the at the least one radiation emitting element via at least one transition material, wherein the at least one transition material is arranged in a manner that the thermal radiation and the optical radiation travel through the at least one transition material prior to be received by the at least one radiation sensitive element.

Embodiment 39: The method according to the preceding Embodiment, wherein the controlling the output of the at least one heating unit further comprises determining a presence of:
at least one further object apart from the at least one radiation emitting element by using the emissivity of the at least one radiation emitting element; or
of a boil-dry condition in the at least one radiation emitting element after an aqueous liquid has been completely evaporated by using a temporal course of the emission temperature of the at least one radiation emitting element;

and preventing an operation of the at least one heating unit after the presence has been confirmed.

Embodiment 40: The method according to the preceding Embodiment, wherein
the at least one radiation emitting element is selected from at least one piece of cookware; and
the at least one further object is selected from at least one of a plastic container or a burn stain located on the ceramic glass cooktop.

### BRIEF DESCRIPTION OF THE FIGURES

Further optional details and features of the invention are evident from the description of preferred exemplary embodiments which follows in conjunction with the dependent Embodiments. In this context, the particular features may be implemented alone or in any reasonable combination. The invention is not restricted to the exemplary embodiments. The exemplary embodiments are shown schematically in the figures. Identical reference numerals in the individual figures refer to identical elements or elements with identical function, or elements which correspond to one another with regard to their functions. In the Figures:

FIG. 1 schematically illustrates a preferred embodiment of a heating system comprising a device for monitoring an emission temperature of at least one radiation emitting element according to the present invention;

FIG. 2 schematically illustrates a further preferred embodiment of a heating system comprising a device for monitoring an emission temperature of at least one radiation emitting element according to the present invention;

FIG. 3 illustrates experimental data obtained by measurements performed on a preferred embodiment of a heating system according to the present invention; and

FIG. 4 schematically illustrates a preferred embodiment of a method for heating at the least one radiation emitting element to an emission temperature comprising a method for monitoring an emission temperature of at least one radiation emitting element according to the present invention.

### EXEMPLARY EMBODIMENTS

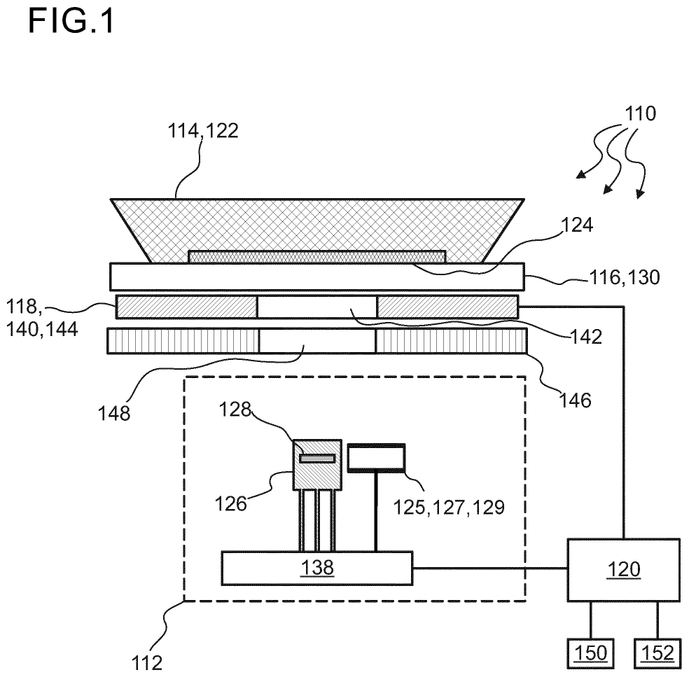

FIG. 1 illustrates, in a highly schematic fashion, an exemplary embodiment of a heating system 110 comprising at least one device 112 for monitoring an emission temperature of at least one radiation emitting element 114 according to the present invention. The heating system 110 further comprises at least one transition material 116, at least one heating unit 118 for heating the radiation emitting element 114 via the transition material 116, and at least one control unit 120. Thus, the heating system 110 is configured to heat the at least one radiation emitting element 114 to emit thermal radiation at the emission temperature. As shown in FIG. 1, the radiation emitting element 114 may specifically be a piece of cookware 122, such as a pot or a pan; however a further piece of cookware 122 may also be feasible. Specifically, at least a partition of the radiation emitting element 114 may emit a predominant portion of the thermal radiation, wherein the partition may, more specifically, be selected from a bottom part 124 of the radiation emitting element 114 which may, preferably, be placed at the at least one transition material 116 in an adjacent fashion.

The device 112 comprises at least one light source 125 which may, particularly, be selected from an incandescent lamp 127 or a thermal infrared emitter 129. The light source 125 is configured to emit optical radiation at least partially towards the at least one radiation emitting element 114. The device 112 comprises at least one radiation sensitive element 126. The radiation sensitive element 126 has at least one sensor region 128. The sensor region 128 comprises at least one photosensitive material selected from at least one photoconductive material. The sensor region 128 is designated for generating at least one sensor signal depending on an intensity of the thermal radiation emitted by the at least one radiation emitting element 114 and received by the sensor region 128. The sensor region 128 is further designated for generating at least one further sensor signal depending on an intensity of the optical radiation emitted by the at least one light source 125 and received by the sensor region 128 within at least one further wavelength range. The radiation sensitive element 126 is arranged in a manner that the thermal radiation travels through at least through one transition material 116 prior to being received by the at least one radiation sensitive element 126. At least one of the at least one light source 125 and the at least one radiation sensitive element 126 is arranged in a manner that the optical radiation travels through the at least one transition material 116 and impinges the at least one radiation emitting element 114 prior to being received by the at least one radiation sensitive element 126. The transition material 116 is at least partially transparent for the thermal radiation within the two individual wavelength ranges. The transition material 116 may be selected from at least one ceramic material 130 as, typically, used in a ceramic glass cooktop.

The device 112 further comprises at least one evaluation unit 138. The evaluation unit 138 is configured to determine the emission temperature of the at least one radiation emitting element 114 by using values for the intensity of the thermal radiation and the optical radiation. The evaluation unit 138 may further be configured to determine an emissivity of the at least one radiation emitting element 114. The emissivity may relate to an effectivity of the at least one radiation emitting element 114 to emit the thermal radiation. Specifically, the at least one evaluation unit 138 may be configured to determine the emissivity of the at least one radiation emitting element 114 as a function of the at least one further sensor signal depending on an intensity of the optical radiation emitted by the at least one light source 125, as generated by the at least one radiation sensitive element 126. Optical properties, specifically spectral properties, of the optical radiation can be predetermined by using the light source 125. Specifically, the light source 125 may emit a known spectrum at least partially towards the radiation emitting element 114. Thus, a variation of the optical radiation induced by an interaction with the radiation emitting element 114 can be determined. Such a variation may, specifically, be related to the emissivity of the radiation emitting element 114. In other words, the determined variation of the optical radiation may, specifically, be related to the emissivity of the radiation emitting element 114. Thus, the emissivity of the radiation emitting element can be represented by a function of the further sensor signal. The function may, specifically, consider initial optical properties of the optical radiation as emitted by the light source 125 before interaction with the radiation emitting element 114. The evaluation unit 138 may specifically be connected to the radiation sensitive element 126 and/or the light source 125. A connection between the evaluation device 138 and the radiation sensitive element 126 and/or the light source 125 may be wire bound and/or wireless.

As already indicated above, the heating system 110 further comprises at least one control unit 120. The control unit 120 is designated for controlling an output of the at least one heating unit 118 based on the emission temperature of the at least one radiation emitting element 114 determined by the device 112 for monitoring the emission temperature of at least one radiation emitting element 114. The heating unit 118 may comprise at least one heating element 140 having at least one opening 142 designated in a manner that the thermal radiation emitted by the at least one radiation emitting 114 element travels through the at least one opening 142. As schematically depicted in FIG. 1, the heating unit 118 may comprise an induction coil 144 having a hole in a central area of the induction coil 144. The induction coil 144 may be designed for heating the least one radiation emitting element 114 by using at least one of thermal heat or electromagnetic induction. Additionally or alternatively, the heating element 140 may comprise at least one infrared halogen lamp (not depicted here).

The heating system 110 may, further, comprise at least one heat shielding 146. The heat shielding 146 may be designated for shielding the at least one device 112 for monitoring the emission temperature of the at least one radiation emitting element 114 from the at least one heating unit 118. As illustrated in FIG. 1, the heat shielding 146 may comprise at least one aperture 148 designated in a manner that the thermal radiation emitted by the at least one radiation emitting element 114 travels through the at least one aperture 148.

The heating system 110 may, further, comprise at least one setting element 150. The setting element 150 may be configured to receive at least one piece of information which can be inputted by at least one user of the heating system 110. As an example, the user may set an emission temperature of the radiation emitting element to a desired value by using the setting element 150. The setting element 150 may, specifically, be connected to the control unit 120 via a wire bound connection and/or a wireless connection.

The heating system 110 may, further, comprise at least one notification unit 152. The notification unit 152 may be configured to provide at least one further piece of information to the at least one user of the heating system 110. As an example, the notification unit 152 may be configured to display an actual value and/or a predefined value and/or a desired value of the emission temperature of the radiation emitting element 114. Alternatively or in addition, the notification unit 152 may be configured to display at least one warning, such as a presence of the at least one further object that may, accidentally or deliberately, assume the location of the at least one piece of cookware 122 on top of the transition material 116 used as the cooktop, such as a plastic container or a burn stain, and that may constitute a potential fire hazard; or that an operation of the cooktop is prevented hereby. The notification unit 152 may, specifically, be connected to the control unit 120 via a wire bound connection and/or a wireless connection.

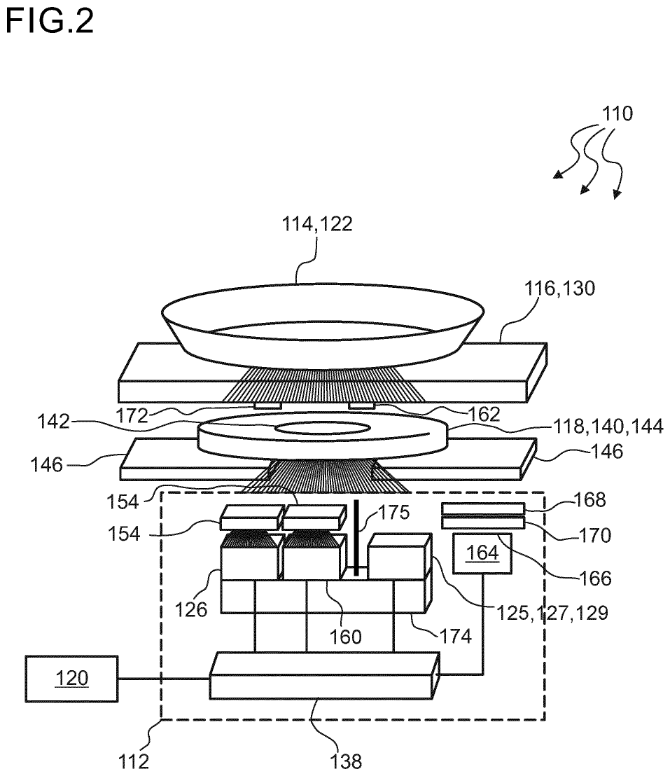

FIG. 2 illustrates, again in a highly schematic fashion, a further exemplary embodiment of the heating system 110 comprising the at least one device 112 for monitoring an emission temperature of the at least one radiation emitting element 114 according to the present invention. The embodiment as shown in FIG. 2 is similar to the embodiment as shown in FIG. 1, so that for a large number of components, reference may be made to the description of FIG. 1 above.

The device 112 may specifically comprise one or more radiation sensitive elements 126. The one or more radiation sensitive elements 126 may be covered by one or more individual optical filters 154. Each individual optical filter 154 may filter a different wavelength range of the thermal radiation before the thermal radiation is received by the one or more radiation sensitive elements 126, e.g. since they may comprise different materials. However, the individual optical filters 154 may also be identical. Additionally or alternatively, the radiation sensitive elements 126 may at least partially be different radiation sensitive elements 126, which may differ with respect to their sensitivity for different wavelengths of the thermal radiation, e.g. since the radiation sensitive elements 126 may at least partially comprise different photosensitive materials. At least one radiation sensitive element 126 may be configured for receiving the thermal radiation emitted by the at least one radiation emitting element 114, wherein at least one further radiation sensitive element (not depicted here) may be configured for receiving the optical radiation emitted by the at least one light source 125. Specifically, one radiation sensitive element 126 may be configured for receiving the thermal radiation emitted by the at least one radiation emitting element 114, wherein one further radiation sensitive element may be configured for receiving the optical radiation emitted by the at least one light source 125.

As FIG. 2 shows, the device 112 may, further, comprise at least one further radiation sensitive element 160. The at least one further radiation sensitive element 160 may be designated for generating at least one still further sensor signal depending on the intensity of further thermal radiation emitted by the at least one transition material 116 within at least one still further wavelength range. The at least one further radiation sensitive element 160 may be covered by at least one of the individual optical filters 154. The at least one transition material 116 may not be transparent or only partially transparent for the thermal radiation emitted by the radiation emitting element 114 within the at least one still further wavelength range. The at least one evaluation unit 138 may further be configured to take into account the at least one still further sensor signal measured by the at least one further radiation sensitive element 160 when determining the emission temperature of the at least one radiation emitting element 114. The at least one evaluation unit 138 may further be configured to correct the intensity of the thermal radiation and/or the optical radiation by removing a contribution of the intensity of further thermal radiation emitted by the at least one transition material 116 from the intensity of the thermal radiation emitted by the at least one radiation emitting element 114 and/or the optical radiation emitted by the at least one light source 125.

The device 112 may, further, comprise at least one temperature sensor 162. The at least one temperature sensor 162 may be designated for monitoring a temperature of the transition material 116. Thus, the temperature sensor 162 may be thermally coupled to the transition material 116. Specifically, the temperature sensor 162 may be attached to the transition material 116. Additionally or alternatively, the temperature sensor 162 may be designated for monitoring a temperature of the radiation sensitive element 114 or further components of the heating system 110. The at least one evaluation unit 138 may further be configured to take into account the temperature measured by the at least one temperature sensor 162 when determining the emission temperature of the at least one radiation emitting element 114. The at least one temperature sensor 162 may specifically be designated for monitoring the temperature of a portion of the at least one transition material 116 which is passed by an optical path between the at least one radiation emitting element 114 and the at least one radiation sensitive element 126.

The device 112 may, further, comprise at least one reference radiation sensitive element 164. The at least one reference radiation sensitive element 164 may have at least one covered sensor region 166. The at least one covered sensor region 166 may comprise the same photosensitive material as the at least one radiation sensitive element 126 but may be covered in a manner to impede that the reference radiation sensitive 164 element receives the thermal radiation emitted by the at least one radiation emitting element 114 and the optical radiation emitted by the at least one light source 125. The at least one covered sensor region 166 may be designated for generating at least one reference signal. The at least one evaluation unit 138 may, further, be configured to take into account the at least one reference signal when determining the emission temperature of the at least one radiation emitting element 114. The at least one covered sensor region 166 may be covered by a radiation absorptive layer 168 and/or a radiation reflective layer 170. The radiation absorptive layer 168 may be designed to absorb the thermal radiation and/or the optical radiation. The radiation reflective layer 170 may be designed to reflect the thermal radiation and/or the optical radiation.

The device 112 may, further, comprise at least one presence sensor 172. The at least one presence sensor 172 may be configured to determine at least one further object which is located in a manner that the thermal radiation may travel through the at least one further object before it may be received by the at least one radiation sensitive element 126. The at least one further object may be not transparent or partially transparent for the thermal radiation emitted by the at least one radiation emitting element 114 and/or the optical radiation emitted by the at least one light source 125. The at least one further object may be selected from at least one of a plastic container or a burn stain located on the ceramic material 130. The at least one presence sensor 172 may be selected from at least one of a time-of-flight detector, a presence detector, or a proximity detector.

The device 112 may, further, comprise at least one thermoelectric cooler 174. The thermoelectric cooler 174 may be configured to cool at least the at least one radiation sensitive element 126 and/or the at least one light source 125. The at least one radiation sensitive element 126 and/or the at least one light source 125 may be thermally coupled to the thermoelectric cooler 174. Specifically, the at least one radiation sensitive element 126 and/or the at least one light source 125 may be attached to the thermoelectric cooler 174. Further, the thermoelectric cooler 174 may be configured to cool the at least one further radiation sensitive element 160. The at least one further radiation sensitive element 160 may be thermally coupled to the thermoelectric cooler 174. Specifically, the at least one further radiation sensitive element 160 may be attached to the thermoelectric cooler 174.

The device 112 may further comprise at least one optical radiation shielding 175. The optical radiation shielding 175 may be configured to shield at least one of the at least one radiation sensitive element 126 and the at least one further radiation sensitive element 160 from being directly illuminated by the optical radiation emitted by the at least one light source 125. The optical radiation shielding 175 may comprise at least one solid material absorbing and/or reflecting the optical radiation, e.g. a synthetic plastic material or a metal. The optical radiation shielding 175 may be arranged between the light source 125 and the at least one radiation sensitive element 126 and/or the at least one further radiation sensitive element 160.

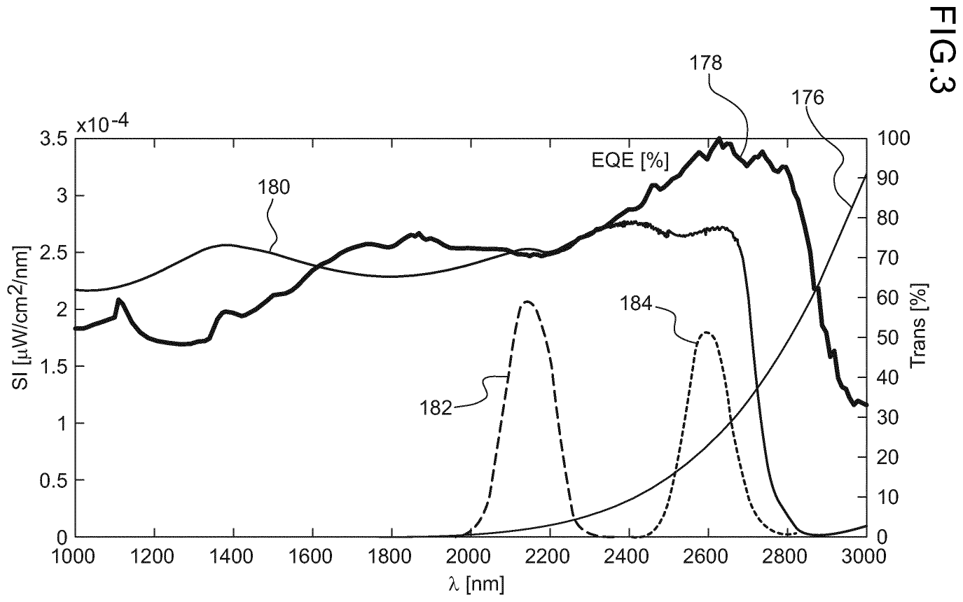

FIG. 3 illustrates experimental data obtained by measurements on a preferred embodiment of the heating system 110 comprising the device 112 for monitoring the emission temperature of the at least one radiation emitting element 114 according to the present invention. Specifically, FIG. 3 illustrates a wavelength dependence of several optical variables. Firstly, a theoretical spectral irradiance SI of a black body at 80° C. is denoted by reference sign 176. The black body may be an arbitrary idealized physical body that absorbs all incident radiation. As the skilled person will know, such a black body emits radiation according to Planck's law, meaning that the black body has a spectrum that is determined by the temperature alone and not by the shape or composition of the black body. As FIG. 3 shows, the spectral irradiance SI increases strongly after a wavelength A of about 2000 nm.

Further, FIG. 3 illustrates a measured external quantum efficiency (EQE) of a PbS detector denoted by reference sign 178. As the skilled person will know, the EQE refers to the ratio of the number of charge carriers generated by the detector over the number of incident photons at a certain wavelength A. As FIG. 3 shows, the EQE of the PbS detector steadily increases with a maximum EQE at around 2600 nm before it rapidly decreases again for higher wavelengths A. This behavior is in good agreement with a transmission spectrum of a particular ceramic material used for the present invention selected from an LAS system known as CERAN® denoted by reference sign 180. As FIG. 3 shows, the transmission of this particular ceramic material also rapidly decreases after around 2600 nm. Above 2800 nm this particular ceramic material blocks almost all radiation. As a result, the at least one further wavelength range at which the at least one further radiation sensitive element 160 as described above may operate can be selected from at least one wavelength of above 2.8 μm to 3.2 μm.

Further shown in FIG. 3 are exemplary transmission spectra of two individual optical filters 154, the transmission spectra are denoted here by reference signs 182 and 184, respectively. Herein, the transmission spectra 182, 184 correspond to the at least two individual wavelength ranges that may, preferably, comprise a first individual wavelength range and a second individual wavelength range. As an example, the at least one photoconductive material may comprise lead sulfide (PbS), wherein the transmission spectra 182, 184 may be selected from a wavelength of 0.8 μm to 2.8 μm. As a further example, the at least one photoconductive material may comprise lead selenide (PbSe), wherein the transmission spectra 182, 184 may be selected from a wavelength of 0.8 μm to 5 μm.

As further depicted in FIG. 3, each individual optical filter 154 may have a narrow transmission window. Wavelengths A within the transmission window may pass the individual optical filter 154, so that they can be received by the radiation sensitive element 126. There may specifically be no or only little overlap between transmission windows of different individual optical filters 154. Thus, the individual wavelength ranges which are received by the radiation sensitive elements 126 behind the individual optical filters 154 may be clearly defined against each other. As an alternative, one of the transmission spectrum may be completely comprised by the other transmission spectrum (not depicted here).

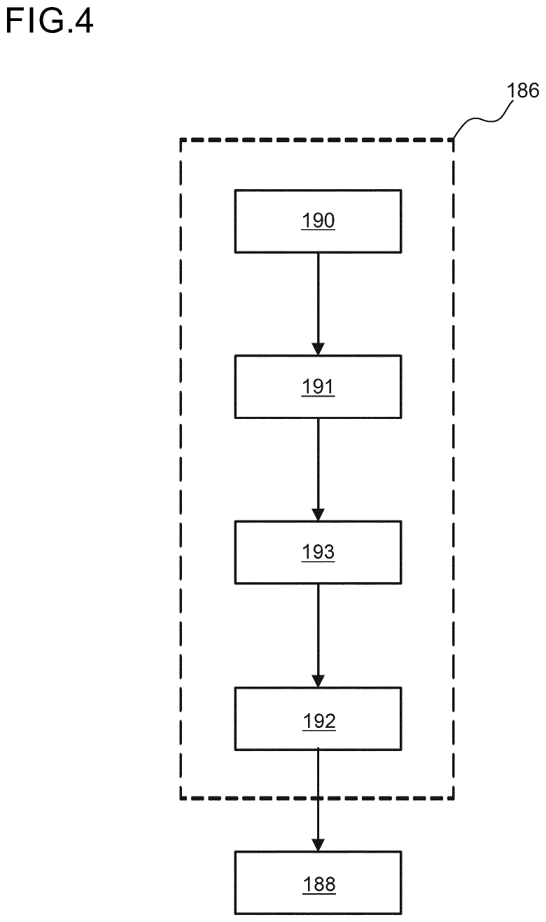

FIG. 4 schematically illustrates a preferred embodiment of a method for heating at the least one radiation emitting element 114 to an emission temperature which comprises a method for monitoring an emission temperature of at least one radiation emitting element 114 according to the present invention.

The method for heating the at least one radiation emitting element 114 to the emission temperature comprises the following steps:
a monitoring step 186, comprising monitoring the emission temperature of the at least one radiation emitting element 114, which emits thermal radiation at the emission temperature;
a controlling step 188, comprising controlling the output of the at least one heating unit 110 based on the emission temperature of the at least one radiation emitting element 114 as determined by the method for monitoring the emission temperature of the at least one radiation emitting element 114.

The controlling of the output of the at least one heating unit 110 may further comprise determining a presence of at least one further object apart from the at least one radiation emitting element 114, specifically a plastic container or a burn stain, by using the emissivity of the at least one radiation emitting element 114. The controlling of the output of the at least one heating unit 110 may further comprise determining a presence of a boil-dry condition in the at least one radiation emitting element 114 after an aqueous liquid has been completely evaporated by using a temporal course of the emission temperature of the at least one radiation emitting element 114, thereby, opening an opportunity to prevent an operation of the heating unit 110 after the presence has been confirmed.

The method for monitoring the emission temperature of the at least one radiation emitting element 114 comprises the following steps:
a generating step 190, comprising generating the at least one sensor signal by using at the least one radiation sensitive element 126 having at least one sensor region 128 comprising a photosensitive material selected from a photoconductive material, wherein the at least one sensor region 128 is designated for generating the at least one sensor signal depending on an intensity of the thermal radiation emitted by the at least one radiation emitting element 114 and received by the sensor region 128 within at least one wavelength range;
an emitting step 191, comprising emitting optical radiation at least partially towards the at least one radiation emitting element 114 by using the at least one light source 125;
a further generating step 193, comprising generating at least one further sensor signal by using the at least one radiation sensitive element 126, wherein the sensor region 128 is further designated for generating the at least one further sensor signal depending on an intensity of the optical radiation emitted by the at least one light source and received by the sensor region 128 within at least one further wavelength range; and
a determining step 192, comprising determining the emission temperature of the at least one radiation emitting element 114 by evaluating the sensor signals of the at least one radiation sensitive element 126 by using the at least one evaluation unit 138, wherein the at least one evaluation 138 unit is configured to determine the emission temperature of the at least one radiation emitting element 114 by using values for the intensity of the thermal radiation and the optical radiation.

### LIST OF REFERENCE NUMBERS

110 heating system
112 device
114 radiation emitting element
116 transition material
118 heating unit
120 control unit
122 piece of cookware
124 bottom part
125 light source
126 radiation sensitive element
127 incandescent lamp
128 sensor region
129 thermal infrared emitter
130 ceramic material
138 evaluation unit
140 heating element
142 opening
144 induction coil
146 heat shielding
148 aperture
150 setting element
152 notification unit
154 individual optical filter
160 further radiation sensitive element
162 temperature sensor
164 reference radiation sensitive element
166 covered sensor region
168 radiation absorptive layer
170 radiation reflective layer
172 presence sensor
174 thermoelectric cooler
175 optical radiation shielding
176 spectral irradiance of a black body at 80° C.
178 external quantum efficiency (EQE) of a PbS detector
180 transmission spectrum of a particular ceramic material known as CERAN®
182 exemplary transmission spectrum of a first individual optical filter
184 exemplary transmission spectrum of a second individual optical filter
186 monitoring step
188 controlling step
190 generating step
191 emitting step
192 determining step
193 further generating step

1. A device for monitoring an emission temperature of at least one radiation emitting element, wherein the at least one radiation emitting element emits thermal radiation at the emission temperature, the device comprising
at least one light source, wherein the light source is configured to emit optical radiation at least partially towards the at least one radiation emitting element;
at least one radiation sensitive element, wherein the at least one radiation sensitive element has at least one sensor region, wherein the at least one sensor region comprises at least one photosensitive material selected from at least one photoconductive material, wherein the at least one sensor region is designated for generating at least one sensor signal depending on an intensity of the thermal radiation emitted by the at least one radiation emitting element and received by the sensor region within at least one wavelength range, wherein the sensor region is further designated for generating at least one further sensor signal depending on an intensity of the optical radiation emitted by the at least one light source and received by the sensor region within at least one further wavelength range, wherein the at least one radiation sensitive element is arranged in a manner that the thermal radiation travels through at least one transition material prior to being received by the at least one radiation sensitive element, wherein at least one of the at least one light source and the at least one radiation sensitive element is arranged in a manner that the optical radiation travels through the at least one transition material and impinges the at least one radiation emitting element prior to being received by the at least one radiation sensitive element; and
at least one evaluation unit, wherein the at least one evaluation unit is configured to determine the emission temperature of the at least one radiation emitting element by using values for the intensity of the thermal radiation and the optical radiation.

2. The device according to claim 1, wherein the at least one light source is or comprises an incandescent lamp or a thermal infrared emitter, wherein the thermal infrared emitter is a micro-machined thermally emitting device which comprises a radiation emitting surface.

3. The device according to claim 1, further comprising
at least one further radiation sensitive element, wherein the at least one further radiation sensitive element is designated for generating at least one still further sensor signal depending on the intensity of further thermal radiation emitted by the at least one transition material within at least one still further wavelength range, wherein the at least one transition material is not transparent or only partially transparent for the thermal radiation emitted by the radiation emitting element within the at least one still further wavelength range of the further thermal radiation,
wherein the at least one evaluation unit is further configured to take into account the at least one still further sensor signal measured by the at least one further radiation sensitive element when determining the emission temperature of the at least one radiation emitting element.

4. The device according to any claim 1, wherein the at least one photoconductive material comprises lead sulfide, wherein the at least one wavelength range and the at least one further wavelength range are selected from at least one wavelength of 0.8 μm to 2.8 μm, wherein the at least one transition material is selected from the at least one ceramic material used in a ceramic glass cooktop, and wherein the at least one still further wavelength range is selected from at least one wavelength of above 2.8 μm to 3.2 μm at which the at least one ceramic material is not transparent or only partially transparent for the thermal radiation.

5. The device according to claim 1, wherein the at least one wavelength range of the thermal radiation is completely comprised by the at least one further wavelength range of the optical radiation, or vice versa.

6. The device according to claim 1, wherein the at least one evaluation unit is further configured to determine an emissivity of the at least one radiation emitting element, wherein the emissivity relates to an effectivity of the at least one radiation emitting element to emit the thermal radiation.

7. The device according to claim 6, wherein the at least one evaluation unit is configured to determine the emissivity of the at least one radiation emitting element as a function of the at least one further sensor signal depending on an intensity of the optical radiation emitted by the at least one light source.

8. The device according to claim 1, further comprising
at least one temperature sensor, wherein the at least one temperature sensor is designated for monitoring a temperature in at least one of
the at least the one radiation sensitive element; or
the at least one transition material
wherein the at least one evaluation unit is further configured to take into account the temperature measured by the at least one temperature sensor when determining the emission temperature of the at least one radiation emitting element.

9. The device according to claim 1, further comprising
at least one reference radiation sensitive element, wherein the at least one reference radiation sensitive element has at least one covered sensor region, wherein the at least one covered sensor region comprises the same photosensitive material as the at least one radiation sensitive element and is being-covered in a manner to impede that the reference radiation sensitive element receives the thermal radiation emitted by the at least one radiation emitting element, wherein the at least one the covered sensor region is designated for generating at least one reference signal,
wherein the at least one evaluation unit is further configured to take into account the at least one reference signal when determining the emission temperature of the at least one radiation emitting element.

10. The device according to claim 1, further comprising
at least one presence sensor, wherein the at least one presence sensor is configured to determine at least one further object which is located in a manner that the thermal radiation travels through the at least one further object prior to be received by the at least one radiation sensitive element, wherein the at least one further object is not transparent or partially transparent in at least one of the at least one wavelength range of the thermal radiation emitted by the at least one radiation emitting element and the at least one further wavelength range of the optical radiation emitted by the at least one light source.

11. The device according to claim 1, further comprising
at least one optical radiation shielding, wherein the optical radiation shielding is configured to shield at least one of the at least one radiation sensitive element and the at least one further radiation sensitive element from being directly illuminated by the optical radiation emitted by the at least one light source.

12. A heating system for heating at the least one radiation emitting element to emit thermal radiation at an emission temperature, the system comprising:
at least one device for monitoring an emission temperature of at least one radiation emitting element according to claim 1, wherein the at least one radiation emitting element emits thermal radiation at the emission temperature;
at least one transition material, wherein the at least one transition material is arranged in a manner that the thermal radiation and the optical radiation travel through the at least one transition material prior to being received by the at least one radiation sensitive element, wherein the at least one transition material is at least partially transparent for the thermal radiation and the optical radiation;
at least one heating unit, wherein the at least one heating unit is designated for heating the at the least one radiation emitting element via the at least one transition material; and
at least one control unit, wherein the at least one control unit is designated for controlling an output of the at least one heating unit based on the emission temperature of the at least one radiation emitting element determined by the device for monitoring the emission temperature of at least one radiation emitting element.

13. The system according to claim 12, wherein the at least one heating unit comprises at least one heating element having at least one opening designated in a manner that the thermal radiation emitted by the at least one radiation emitting element and the optical radiation emitted by the at least one light source travel through the at least one opening.

14. The system according to claim 12, further comprising
at least one heat shielding, wherein the at least one heat shielding is designated for shielding the at least one device for monitoring the emission temperature of the at least one radiation emitting element from the at least one heating unit, and wherein the at least one heat shielding comprises at least one aperture designated in a manner that the thermal radiation emitted by the at least one radiation emitting element and the optical radiation emitted by the at least one light source travel through the at least one aperture.

15. A method for monitoring an emission temperature of at least one radiation emitting element, wherein the at least one radiation emitting element emits thermal radiation at the emission temperature, the method comprising the following steps:
generating at least one sensor signal by using at least one radiation sensitive element, wherein the at least one radiation sensitive element has at least one sensor region, wherein the at least one sensor region comprises a photosensitive material selected from a photoconductive material, wherein the at least one sensor region is designated for generating the at least one sensor signal depending on an intensity of the thermal radiation emitted by the at least one radiation emitting element and received by the sensor region within at least one wavelength range;
emitting optical radiation at least partially towards the at least one radiation emitting element by using the at least one light source;
generating at least one further sensor signal by using the at least one radiation sensitive element, wherein the sensor region is further designated for generating the at least one further sensor signal depending on an intensity of the optical radiation emitted by the at least one light source and received by the sensor region within at least one further wavelength range; and
determining the emission temperature of the at least one radiation emitting element by evaluating the sensor signals of the at least one radiation sensitive element by using the at least one evaluation unit, wherein the at least one evaluation unit is configured to determine the emission temperature of the at least one radiation emitting element by using values for the intensity of the thermal radiation and the optical radiation.

16. The method according to claim 15, further comprising the following steps:
generating at least one still further sensor signal depending on the intensity of further thermal radiation emitted by the at least one transition material within at least one still further wavelength range, wherein the at least one transition material is not transparent or only partially transparent for the thermal radiation emitted by the radiation emitting element within the at least one still further wavelength range of the further thermal radiation; and
determining the emission temperature of the at least one radiation emitting element by taking into account the at least one still further sensor signal when determining the emission temperature of the at least one radiation emitting element.

17. A method for heating the at least one radiation emitting element to emit thermal radiation at an emission temperature, the method comprising the following steps:
monitoring an emission temperature of at least one radiation emitting element, wherein the at least one radiation emitting element emits thermal radiation at the emission temperature;
controlling an output of at least one heating unit based on the emission temperature of the at least one radiation emitting element determined by the method for monitoring an emission temperature of at least one radiation emitting element according to claim 16, wherein the at least one heating unit is designated for heating the at the least one radiation emitting element via at least one transition material, wherein the at least one transition material is arranged in a manner that the thermal radiation and the optical radiation travel through the at least one transition material prior to being received by the at least one radiation sensitive element.

18. The method according to claim 17, wherein the controlling the output of the at least one heating unit further comprises determining a presence of
at least one further object apart from the at least one radiation emitting element by using the emissivity of the at least one radiation emitting element; or
of a boil-dry condition in the at least one radiation emitting element after an aqueous liquid has been completely evaporated by using a temporal course of the emission temperature of the at least one radiation emitting element;
and preventing an operation of the at least one heating unit after the presence has been confirmed.
